(19) United States
(12) Patent Application Publication
(10) Pub. No.: US 2026/0292630 A1
(43) Pub. Date: Sep. 24, 2026

(54) BEAM INDICATIONS FOR A CANDIDATE CELL GROUP IN A LOWER LAYER TRIGGERED MOBILITY OPERATION

(71) Applicant: QUALCOMM Incorporated, San Diego, CA (US)

(72) Inventors: Fang YUAN, Beijing (CN); Yan ZHOU, San Diego, CA (US)

(21) Appl. No.: 19/477,385

(22) PCT Filed: May 12, 2023
(86) PCT No.: PCT/CN2023/093813

§ 371 Date: Oct. 21, 2025

(51) Int. Cl. H04W 36/08; H04L 5/00

(52) U.S. Cl. CPC H04W 36/08; H04L 5/0094

(57) ABSTRACT

Various aspects of the present disclosure generally relate to wireless communication. In some aspects, a user equipment (UE) may transmit UE capability information indicative of a capability of the UE associated with activation, prior to reception of a beam indication associated with a candidate cell of a cell set configured for a lower layer triggered mobility (LTM) operation, of at least one transmission configuration indicator (TCI) associated with the candidate cell. The UE may receive configuration information corresponding to the LTM operation. The UE may perform an LTM handover operation based on the configuration information and the at least one TCI. Numerous other aspects are described.

### FIELD OF THE DISCLOSURE

Aspects of the present disclosure generally relate to wireless communication and specifically relate to techniques and apparatuses for beam indications for a candidate cell group in a lower layer triggered mobility operation.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, system bandwidth and/or device transmit power). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies, massive multiple-input multiple-output (MIMO), disaggregated network architectures and network topology expansions, multiple-subscriber implementations, and/or high-precision positioning, among other examples. As the demand for mobile broadband access continues to increase, further improvements in NR may be implemented, and other radio access technologies such as 6G may be introduced to further advance mobile broadband evolution.

In some cases, a user equipment (UE) may be configured with a lower layer triggered mobility (LTM) configuration to enable the UE to efficiently transition between multiple cells. Layer 1 (L1) and/or Layer 2 (L2) signaling may be referred to as “lower layer” signaling and may be used to activate and/or deactivate candidate cells in a set of cells configured for L1/L2 mobility and/or to provide reference signals for measurement by a UE, by which the UE may select a candidate beam as a target beam for a lower layer handover operation. LTM may refer to L1/L2 mobility in which cell switching is triggered by the network. To facilitate LTM, a target beam may be indicated by the network to the UE.

### SUMMARY

Some aspects described herein relate to a user equipment (UE) for wireless communication. The UE may include one or more memories and one or more processors coupled to the one or more memories. The one or more processors may be configured to transmit UE capability information indicative of a capability of the UE associated with activation, prior to reception of a beam indication associated with a candidate cell of a cell set configured for a lower layer triggered mobility (LTM) operation, of at least one transmission configuration indicator (TCI) associated with the candidate cell. The one or more processors may be configured to receive configuration information corresponding to the LTM operation. The one or more processors may be configured to perform an LTM handover operation based on the configuration information and the at least one TCI.

Some aspects described herein relate to a network node for wireless communication. The network node may include one or more memories and one or more processors coupled to the one or more memories. The one or more processors may be configured to receive UE capability information indicative of a capability of a UE associated with activation, prior to transmission of a beam indication associated with a candidate cell of a cell set configured for an LTM operation, of at least one TCI associated with the candidate cell. The one or more processors may be configured to transmit configuration information corresponding to the LTM operation. The one or more processors may be configured to perform an LTM handover operation based on the configuration information and the at least one TCI.

Some aspects described herein relate to a method of wireless communication performed by a UE. The method may include transmitting UE capability information indicative of a capability of the UE associated with activation, prior to reception of a beam indication associated with a candidate cell of a cell set configured for an LTM operation, of at least one TCI associated with the candidate cell. The method may include receiving configuration information corresponding to the LTM operation. The method may include performing an LTM handover operation based on the configuration information and the at least one TCI.

Some aspects described herein relate to a method of wireless communication performed by a network node. The method may include receiving UE capability information indicative of a capability of a UE associated with activation, prior to transmission of a beam indication associated with a candidate cell of a cell set configured for an LTM operation, of at least one TCI associated with the candidate cell. The method may include transmitting configuration information corresponding to the LTM operation. The method may include performing an LTM handover operation based on the configuration information and the at least one TCI.

Some aspects described herein relate to a non-transitory computer-readable medium that stores a set of instructions for wireless communication by a UE. The set of instructions, when executed by one or more processors of the UE, may cause the UE to transmit UE capability information indicative of a capability of the UE associated with activation, prior to reception of a beam indication associated with a candidate cell of a cell set configured for an LTM operation, of at least one TCI associated with the candidate cell. The set of instructions, when executed by one or more processors of the UE, may cause the UE to receive configuration information corresponding to the LTM operation. The set of instructions, when executed by one or more processors of the UE, may cause the UE to perform an LTM handover operation based on the configuration information and the at least one TCI.

Some aspects described herein relate to a non-transitory computer-readable medium that stores a set of instructions for wireless communication by a network node. The set of instructions, when executed by one or more processors of the network node, may cause the network node to receive UE capability information indicative of a capability of a UE associated with activation, prior to transmission of a beam indication associated with a candidate cell of a cell set configured for an LTM operation, of at least one TCI associated with the candidate cell. The set of instructions, when executed by one or more processors of the network node, may cause the network node to transmit configuration information corresponding to the LTM operation. The set of instructions, when executed by one or more processors of the network node, may cause the network node to perform an LTM handover operation based on the configuration information and the at least one TCI.

Some aspects described herein relate to an apparatus for wireless communication. The apparatus may include means for transmitting UE capability information indicative of a capability of the apparatus associated with activation, prior to reception of a beam indication associated with a candidate cell of a cell set configured for an LTM operation, of at least one TCI associated with the candidate cell. The apparatus may include means for receiving configuration information corresponding to the LTM operation. The apparatus may include means for performing an LTM handover operation based on the configuration information and the at least one TCI.

Some aspects described herein relate to an apparatus for wireless communication. The apparatus may include means for receiving UE capability information indicative of a capability of a UE associated with activation, prior to transmission of a beam indication associated with a candidate cell of a cell set configured for an LTM operation, of at least one TCI associated with the candidate cell. The apparatus may include means for transmitting configuration information corresponding to the LTM operation. The apparatus may include means for performing an LTM handover operation based on the configuration information and the at least one TCI.

Aspects generally include a method, apparatus, system, computer program product, non-transitory computer-readable medium, user equipment, base station, network node, network entity, wireless communication device, and/or processing system as substantially described with reference to and as illustrated by the drawings and specification.

The foregoing has broadly summarized some aspects of the present disclosure. Additional aspects and associated advantages will be described hereinafter. The disclosed aspects may be used as a basis for modifying or designing other aspects for carrying out the same purposes of the present disclosure. Such equivalent aspects do not depart from the scope of the appended claims. Characteristics of the aspects disclosed herein, both their organization and method of operation, together with associated advantages will be better understood from the following description when considered in connection with the accompanying drawings. Each of the drawings is provided for the purposes of illustration and description, and not as a definition of the limits of the claims.

### BRIEF DESCRIPTION OF THE DRAWINGS

The appended drawings illustrate some aspects of the present disclosure, but are not limiting of the scope of the present disclosure because the description may enable other aspects. The same reference numbers in different drawings may identify the same or similar elements.

FIG. 1 is a diagram illustrating an example of a wireless network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4A illustrates an example of a first lower layer triggered mobility (LTM) technique, in accordance with the present disclosure.

FIG. 4B illustrates an example of a second LTM technique, in accordance with the present disclosure

FIG. 5 is a diagram illustrating an example associated with layer-3-based layer 1 measurement operations for LTM, in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the disclosure are described hereinafter with reference to the accompanying drawings. However, this disclosure may be embodied in many different forms and is not to be construed as limited to any specific aspect presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using any quantity of the aspects set forth herein. In addition, the scope of the disclosure is intended to cover an apparatus or method that is practiced using another structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to lower layer triggered mobility (LTM) operations. Some aspects more specifically relate to beam indications for a candidate cell group in an LTM operation. In some examples, a user equipment (UE) may transmit UE capability information to a network node that indicates a capability of the UE associated with activation of a transmission configuration indicator (TCI) state prior to reception of a beam indication. For example, in some aspects, the UE capability information may indicate that the UE supports TCI activation prior to beam indication. In some other aspects, the UE capability information may indicate that the UE supports TCI activation with beam indication. In some aspects, the UE may be provided with a TCI activation communication (e.g., a medium access control (MAC) control element (CE) (MAC CE)) prior to receiving a beam indication. In some other aspects, the UE may be provided with a TCI activation (e.g., in a cell switching command) along with a beam indication associated with a beam of a candidate cell. The UE may activate the TCI, activate the beam, and perform an LTM handover in association with the activated TCI and beam.

Particular aspects of the subject matter described in this disclosure can be implemented to realize one or more of the following potential advantages. By transmitting UE capability information to a network node, some aspects may facilitate coordination between a UE and a network node associated with signaling for TCI and beam activation, thereby improving the efficiency of LTM handovers. For example, by indicating that a UE supports TCI activation prior to beam indication, some aspects of the UE capability information described herein may facilitate an earlier preparation of a UE and a candidate cell for LTM handover. As another example, by indicating that a UE does not support TCI activation prior to beam indication (or by indicating that the UE supports TCI activation with beam indication), some aspects of the UE capability information described herein may enable a network node to include a TCI activation indication in a cell switch command, thereby reducing overhead prior to an LTM handover.

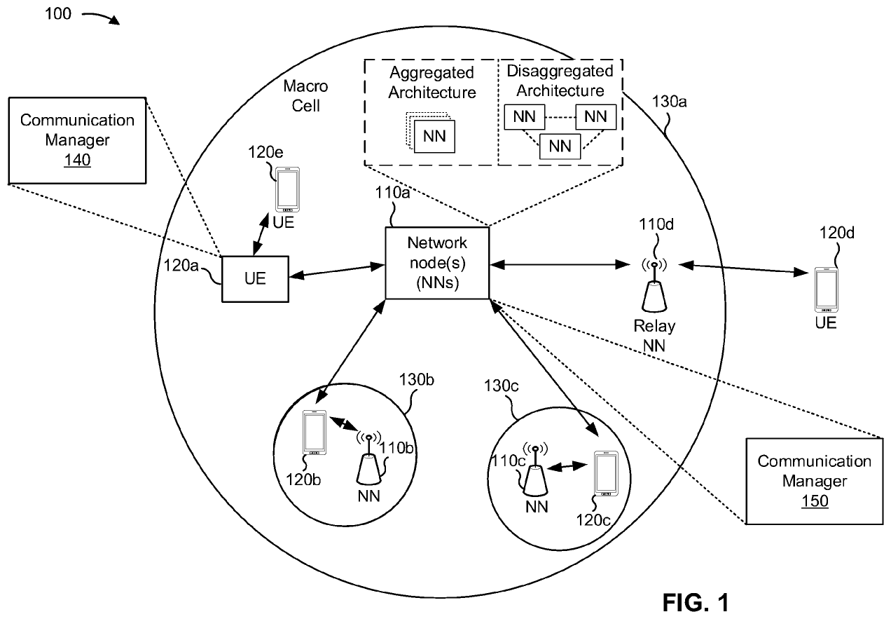

FIG. 1 is a diagram illustrating an example of a wireless network 100 in accordance with the present disclosure. The wireless network 100 may be or may include elements of a 5G (or New Radio (NR)) network or a 6G network, among other examples. The wireless network 100 may include multiple network nodes 110 (also referred to as network entities), shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

A network node 110 may include one or more devices that enable communication between a UE 120 and one or more components of the wireless network 100. A network node 110 may be, may include, or may be referred to as an NR network node, a 6G network node, a Node B, an eNB (for example, in 4G), a gNB (for example, in 5G), an access point (AP), a transmission reception point (TRP), a mobility element of a network, a core network node, a network element, a network equipment, and/or another type of device or devices included in a radio access network (RAN).

A network node 110 may be a single physical node or may be two or more physical nodes. For example, a network node 110 may be a device or system that implements part of a radio protocol stack, a device or system that implements a full protocol stack (such as a full gNB protocol stack), or a collection of devices or systems that collectively implement the full protocol stack. For example, and as shown, a network node 110 may be an aggregated network node, meaning that the network node 110 may use a radio protocol stack that is physically and logically integrated within a single node in the wireless network 100. For example, an aggregated network node 110 may consist of a single standalone base station or a single TRP that uses a full radio protocol stack to enable or facilitate communication between a UE 120 and a core network of the wireless network 100.

Alternatively, and as also shown, a network node 110 may be a disaggregated network node (sometimes referred to as a disaggregated base station), meaning that the network node 110 may use a protocol stack that is physically distributed and/or logically distributed among two or more nodes in the same geographic location or in different geographic locations. In some deployments, disaggregated network nodes 110 may be used in an integrated access and backhaul (IAB) network, in an open radio access network (O-RAN), such as the network configuration sponsored by the O-RAN Alliance, or in a virtualized radio access network (vRAN), also known as a cloud radio access network (C-RAN), to facilitate scaling of communication systems by separating base station functionality into multiple units that can be individually deployed.

The network nodes 110 of the wireless network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a MAC layer, and/or one or more high physical (PHY) layers depending, at least in part, on a functional split, such as a functional split defined by the Third Generation Partnership Project (3GPP). In some examples, a DU may host one or more low PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or low PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a network node 110 may include a combination of one or more CUs, one or more DUs, one or more RUs, one or more IAB nodes, one or more Near-Real Time (Near-RT) RAN Intelligent Controllers (RICs), and/or one or more Non-Real Time (Non-RT) RICs in the wireless network 100. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as within a cloud deployment.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may include one or more control channels and one or more data channels. An uplink control channel may be used to transmit uplink control information (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

In some examples, the wireless network 100 may be configured for half-duplex operation and/or full-duplex operation. In half-duplex operation, a network node 110 and/or a UE 120 may only transmit or receive communications during particular time periods, such as during particular slots, symbols, or other time periods. Half-duplex operation may involve time-division duplexing (TDD), in which transmissions of the network node 110 and transmissions of the UE 120 do not occur in the same time periods (that is, the transmissions do not overlap in time). For example, in half-duplex operation, a wireless communication device may perform only one of transmission or reception in a particular time period. In full-duplex operation, a wireless communication device (such as the network node 110 and/or the UE 120) may transmit and receive communications concurrently (for example, in the same time period). In some examples, full-duplex operation may involve frequency-division duplexing (FDD), in which transmissions of the network node 110 are performed on a first frequency and transmissions of the UE 120 are performed on a second frequency different from the first carrier. In FDD, transmissions of the network node 110 and transmissions of the UE 120 can be performed concurrently. In some examples, a UE 120 may communicate with two network nodes 110 in a configuration that may be referred to as a multi-TRP (mTRP) configuration. In some examples, full-duplex operation may be enabled for a UE 120 but not for a network node 110. For example, a UE 120 may simultaneously transmit an UL transmission to a first network node 110 and receive a DL transmission from a second network node 110 in the same time instance. In some other examples, full-duplex operation may be enabled for a network node 110 but not for a UE 120. For example, a network node 110 may simultaneously transmit a DL transmission to a first UE 120 and receive an UL transmission from a second UE 120 in the same time instance. In some examples, full-duplex operation may be enabled for both a network node 110 and a UE 120. Full-duplex operation increases the capacity of the network and the radio access link.

In some examples, the UE 120 and the network node 110 may perform MIMO communication. “MIMO” generally refers to transmitting and receiving multiple data signals (such as multiple layers or multiple data streams) simultaneously over a radio channel. MIMO may exploit multipath propagation. MIMO may be implemented using spatial processing referred to as precoding, or MIMO may be implemented using spatial multiplexing. In some examples, MIMO may support simultaneous transmission to multiple receivers, referred to as multi-user MIMO (MU-MIMO). Some radio access technologies (RATs) may employ advanced MIMO techniques, such as multiple TRP operation (including redundant transmission or reception on multiple TRPs), reciprocity in the time domain or the frequency domain, single-frequency-network (SFN) transmission, or non-coherent joint transmission (NC-JT).

As described above, in some aspects, the wireless network 100 may be, may include, or may be included in an IAB network. In an IAB network, at least one network node 110 may be an anchor network node that communicates with a core network via a wired backhaul link, such as a fiber connection. An anchor network node 110 may also be referred to as an IAB donor (or IAB-donor), a central entity, and/or a CU, among other examples. An IAB network may include one or more non-anchor network nodes 110, sometimes referred to as relay network nodes or IAB nodes (or IAB-nodes). The non-anchor network node 110 may communicate directly with or indirectly with (for example, via one or more non-anchor network nodes) the anchor network node 110 via one or more backhaul links to form a backhaul path to the core network for carrying backhaul traffic. In various deployments, the backhaul links may be wireless links. Anchor network nodes 110 and/or non-anchor network nodes 110 may also communicate directly with one or more UEs 120 via access links, which may be wireless links for carrying access traffic.

As described above, an IAB network includes an IAB donor that may connect to a core network via a wired connection (for example, a wireline backhaul). For example, an Ng interface of an IAB donor may terminate at a core network. Additionally, or alternatively, an IAB donor may connect to one or more devices of the core network that provide a core access and mobility management function (AMF). As described above, an IAB donor may include a CU, which may perform access node controller (ANC) functions and/or AMF functions. The CU may configure a DU of the IAB donor and/or may configure one or more IAB nodes (for example, a mobile termination (MT) function and/or a DU function of an IAB node) that connect to the core network via the IAB donor. A link between an IAB donor and an IAB node or between two IAB nodes may also be referred to as a backhaul link. In some examples, a backhaul link between an IAB donor and an IAB node or between two IAB nodes may be a wireless backhaul link that provides an IAB node with radio access to a core network via an IAB donor, and optionally via one or more other IAB nodes. Thus, a CU of an IAB donor may control and/or configure the entire IAB network (or a portion thereof) that connects to the core network via the IAB donor, such as by using control messages and/or configuration messages (for example, an RRC configuration message or an F1 application protocol (F1AP) message). Access links may facilitate communications between a UE 120 and an IAB donor or between a UE 120 and an IAB node. For example, network resources for wireless communications (such as time resources, frequency resources, and/or spatial resources) may be shared between access links and backhaul links. A backhaul link may be a primary backhaul link or a secondary backhaul link (for example, a backup backhaul link). In some aspects, a secondary backhaul link may be used if a primary backhaul link fails, becomes congested, and/or becomes overloaded, among other examples.

When a first IAB node controls and/or schedules communications for a second IAB node (for example, when the first IAB node provides DU functions for the MT functions of the second IAB node), the first IAB node may be referred to as a parent IAB node of the second IAB node, and the second IAB node may be referred to as a child IAB node of the first IAB node. A child IAB node of the second IAB node may be referred to as a grandchild IAB node of the first IAB node. Thus, a DU function of a parent IAB node may control and/or schedule communications for child IAB nodes of the parent IAB node. In some examples, a DU function may exercise limited control over communications of a grandchild node, such as via indication of soft resources or restricted beams at a child node associated with the grandchild node. In some examples, in an IAB network, a DU may be referred to as a scheduling node or a scheduling component, and an MT may be referred to as a scheduled node or a scheduled component. A parent IAB node may be an IAB donor or an IAB node, and a child IAB node may be an IAB node or a UE 120. Communications of an MT function of a child IAB node may be controlled and/or scheduled by a parent IAB node of the child IAB node.

A network node 110 that relays communications may be referred to as a relay station, a relay network node, or a relay. A relay station may receive a transmission of data from an upstream station (for example, a network node 110 or a UE 120) and send a transmission of the data to a downstream station (for example, a UE 120 or a network node 110). In this case, the wireless network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

In some examples, a relay station may include an electromagnetic radiation reflective relay network node 110 that can be used to relay signals from a first network node 110 to a second network node 110 or a UE 120. The electromagnetic radiation reflective relay network node 110 can include, for example, a radio frequency reflection array configured to perform radio frequency reflection services. The electromagnetic radiation reflective relay network node 110 can be, for example, a reconfigurable intelligent surface (RIS) (which also can be referred to as an intelligent reflective surface (IRS)).

The UEs 120 may be physically dispersed throughout the wireless network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 may include or may be included in a housing that houses components associated with the UE 120, such as one or more processor components and/or one or more memory components. One or more of the processor components may be coupled with one or more of the memory components and/or other components. For example, the processor components (for example, one or more processors) and the memory components (for example, one or more memories) may be operatively coupled, communicatively coupled, electronically coupled, or electrically coupled with one another.

Some UEs 120 may be considered machine-type communication (MTC) or evolved or enhanced machine-type communication (eMTC) UEs (or further enhanced eMTC (feMTC), or enhanced feMTC (efeMTC), or further evolutions thereof, all of which may be simply referred to as “MTC”). An MTC UE may be, may include, or may be included in or coupled with a robot, an unmanned aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless network 100).

Some UEs 120 may be classified according to different categories in association with different complexities and/or different capabilities. UEs 120 in a first category may facilitate massive IoT in the wireless network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, a UE 120 in the third category (a RedCap UE) may support lower latency communication than a UE 120 in the first category (an NB-IoT UE or an eMTC UE), and a UE 120 in the second category (a mission-critical IoT UE or a premium UE) may support lower latency communication than the UE 120 in the third category. Additionally or alternatively, in some examples, a UE 120 in the third category (a RedCap UE) may support higher wireless communication throughput than a UE 120 in the first category (an NB-IoT UE or an eMTC UE), and a UE 120 in the second category (a mission-critical IoT UE or a premium UE) may support higher wireless communication throughput than the UE 120 in the third category. Additionally or alternatively, in some examples, a UE 120 in the first category (an NB-IoT UE or an eMTC UE) may support longer battery life than a UE 120 in the third category (a RedCap UE), and the UE 120 in the third category may support longer battery life than a UE 120 in the second category (a mission-critical IoT UE or a premium UE).

In some examples, a UE 120 of the third category (a RedCap UE) may have capabilities that satisfy first device or performance requirements (such as parameters specified by Section 4.2.21 of 3GPP Technical Specification 38.306, Release 17) but not second device or performance requirements (such as parameters specified for NR UEs 120 other than UEs 120 of the third category, which may be defined by parameters specified by Section 4 of 3GPP Technical Specification 38.306, Release 17), while a UE 120 of the second category (a mission-critical IoT UE or a premium UE) may have capabilities that satisfy the second device or performance requirements (and also the first device or performance requirements, in some examples). For example, a UE 120 of the third category may support a lower maximum modulation and coding scheme (MCS) (for example, a modulation scheme such as quadrature phase shift keying (QPSK)) than an MCS supported by a UE 120 of the second category (for example, a modulation scheme such as 256-quadrature amplitude modulation (QAM)). As another example, a UE of the third category may support a lower maximum transmit power than a maximum transmit power of a UE of the second category. As another example, a UE 120 of the third category may have a less advanced beamforming capability than a beamforming capability of a UE 120 of the second category (for example, a RedCap UE may not be capable of forming as many beams as a premium UE). As another example, a UE 120 of the third category may require a longer processing time than a processing time of a UE 120 of the second category. As another example, a UE 120 of the third category may include less hardware or less complex hardware (such as fewer antennas, fewer transmit antennas, and/or fewer receive antennas) than a UE 120 of the second category. As another example, a UE 120 of the third category may not be capable of communicating on as wide of a maximum bandwidth part (BWP) as a UE 120 of the second category.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may communicate using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless network 100. In some other deployments and configurations, a UE 120 (instead of a network node 110) may perform, or collaborate or negotiate with one or more other UEs to perform, scheduling operations, resource selection operations, and/or other operations for sidelink communications.

Downlink and uplink resources may include time domain resources (frames, subframes, slots, and/or symbols), frequency domain resources (frequency bands, frequency carriers, subcarriers, resource blocks, and/or resource elements), and/or spatial domain resources (particular transmit directions and/or beam parameters). Frequency domain resources of some bands may be subdivided into BWPs. A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a downlink control information (DCI) configuration to the one or more UEs 120) and/or reconfigured, which means that a BWP can be adjusted in real-time (or near-real-time) based on changing network conditions in the wireless network 100 and/or based on the specific requirements of the one or more UEs 120. This enables more efficient use of the available frequency domain resources in the wireless network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As indicated above, a BWP may be configured as a subset or a part of a total or full component carrier bandwidth and generally forms or encompasses a set of contiguous common resource blocks (CRBs) within the full component carrier bandwidth. In other words, within the carrier bandwidth, a BWP starts at a CRB and may span a set of consecutive CRBs. Each BWP may be associated with its own numerology (indicating a sub-carrier spacing (SCS) and cyclic prefix (CP)). A UE 120 may be configured with up to four downlink BWPs and up to four uplink BWPs for each serving cell. To enable reasonable UE battery consumption, only one BWP in the downlink and one BWP in the uplink are generally active at a given time on an active serving cell under typical operation. The active BWP defines the operating bandwidth of the UE 120 within the operating bandwidth of the serving cell while all other BWPs with which the UE 120 is configured are deactivated. On deactivated BWPs, the UE 120 does not transmit or receive any communications.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

As indicated above, a network node 110 may be a terrestrial network node 110 (for example, a terrestrial base station or entity of a disaggregated base station) or an NTN network node 110. For example, the wireless network 100 may include one or more NTN deployments including a non-terrestrial network node, an NTN network node 110, and/or a relay station. In some examples, a relay station in an NTN deployment may be referred to as a “non-terrestrial relay station.” An NTN may facilitate access to the wireless network 100 for remote areas that may not otherwise be within a coverage area of a terrestrial network node 110, such as over water or remote areas in which a terrestrial network is not deployed. An NTN may provide connectivity for various applications, including satellite communications, IoT, MTC, and/or other applications. An NTN network node 110 may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, a helicopter, and/or a dirigible, among other examples. A UAS platform may include a high-altitude platform station (HAPS), a balloon, a dirigible, and/or an airplane, among other examples.

An NTN network node 110 may communicate directly and/or indirectly with other entities in the wireless network 100 using NTN communication. The other entities may include UEs 120, other NTN network nodes 110 in the one or more NTN deployments, other types of network nodes 110 (for example, stationary, terrestrial, and/or ground-based network nodes), relay stations, and/or one or more components and/or devices included in or coupled with a core network of the wireless network 100. For example, an NTN network node 110 may communicate with a UE 120 via a service link (for example, where the service link includes an access link). Additionally or alternatively, an NTN network node 110 may communicate with a gateway (for example, a terrestrial node providing connectivity for the NTN network node 110 to a data network or a core network) via a feeder link (for example, where the feeder link is associated with an N2 or an N3 interface). Additionally or alternatively, NTN network nodes 110 may communicate directly with one another via an inter-satellite link (ISL). An NTN deployment may be transparent (for example, where the NTN network node 110 operates in a similar manner as a repeater or relay and/or where an access link does not terminate at the NTN network node 110) or regenerative (for example, where the NTN network node 110 regenerates a signal and/or where an access link terminates at the NTN network node 110).

In some examples, a UE 120 may implement power saving features, such as for UEs 120 in an RRC connected mode, an RRC idle mode, or an RRC inactive mode. Power saving features may include, for example, relaxed radio resource monitoring (such as for devices operating in low mobility or in good radio conditions), discontinuous reception (DRX), reduced PDCCH monitoring during active times, and/or power-efficient paging reception.

A UE 120 may operate in association with a DRX configuration (for example, indicated to the UE 120 by a network node 110). DRX operation may enable the UE 120 to enter a sleep mode at various times while in the coverage area of a network node 110 to reduce power consumption for conserving battery resources, among other examples. The DRX configuration generally configures the UE 120 to operate in association with a DRX cycle. The UE 120 may repeat DRX cycles with a configured periodicity according to the DRX configuration. A DRX cycle may include a DRX on duration during which the UE 120 is in an awake mode or in an active state, and one or more durations during which the UE 120 may operate in an inactive state, which may be opportunities for the UE 120 to enter a DRX sleep mode in which the UE 120 may refrain from monitoring for communications from a network node 110. Additionally or alternatively, the UE 120 may deactivate one or more antennas, RF chains, and/or other hardware components or devices while operating in the DRX sleep mode.

The time during which the UE 120 is configured to be in an active state during a DRX on duration may be referred to as an active time, and the time during which the UE 120 is configured to be in an inactive state, such as during a DRX sleep duration, may be referred to as an inactive time. During a DRX on duration, the UE 120 may monitor for downlink communications from one or more network nodes 110. If the UE 120 does not detect and/or does not successfully decode any downlink communications during the DRX on duration, the UE 120 may enter a DRX sleep mode for the inactive time duration at the end of the DRX on duration. Conversely, if the UE 120 detects and/or successfully decodes a downlink communication during the DRX on duration, the UE 120 may remain in the active state for the duration of a DRX inactivity timer (which may extend the active time). The UE 120 may start the DRX inactivity timer at a time at which the downlink communication is received. The UE 120 may remain in the active state until the DRX inactivity timer expires, at which time the UE 120 may transition to the sleep mode for an inactive time duration. Additionally or alternatively, the UE 120 may use a DRX cycle referred to as an extended DRX (eDRX) cycle, such as for use cases that are tolerant to latency. An eDRX cycle may include a relatively longer inactive time relative to a baseline DRX cycle (for example, an eDRX cycle may have a lower ratio of active time to inactive time).

The network nodes 110 and the UEs 120 of the wireless network 100 may communicate using the electromagnetic spectrum, which may be subdivided by frequency or wavelength into various classes, bands, carriers, and/or channels. For example, devices of the wireless network 100 may communicate using one or more operating bands. In some aspects, multiple wireless networks 100 may be deployed in a given geographic area. Each wireless network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different from the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

In some aspects, a UE (e.g., the UE 120) may include a communication manager 140. As described in more detail elsewhere herein, the communication manager 140 may transmit UE capability information indicative of a capability of the UE associated with activation, prior to reception of a beam indication associated with a candidate cell of a cell set configured for an LTM operation, of at least one TCI associated with the candidate cell; receive configuration information corresponding to the LTM operation; and perform an LTM handover operation based on the configuration information and the at least one TCI. Additionally, or alternatively, the communication manager 140 may perform one or more other operations described herein.

In some aspects, a network node (e.g., the network node 110) may include a communication manager 150. As described in more detail elsewhere herein, the communication manager 150 may receive UE capability information indicative of a capability of a UE associated with activation, prior to transmission of a beam indication associated with a candidate cell of a cell set configured for an LTM operation, of at least one TCI associated with the candidate cell; transmit configuration information corresponding to the LTM operation; and perform an LTM handover operation based on the configuration information and the at least one TCI. Additionally, or alternatively, the communication manager 150 may perform one or more other operations described herein.

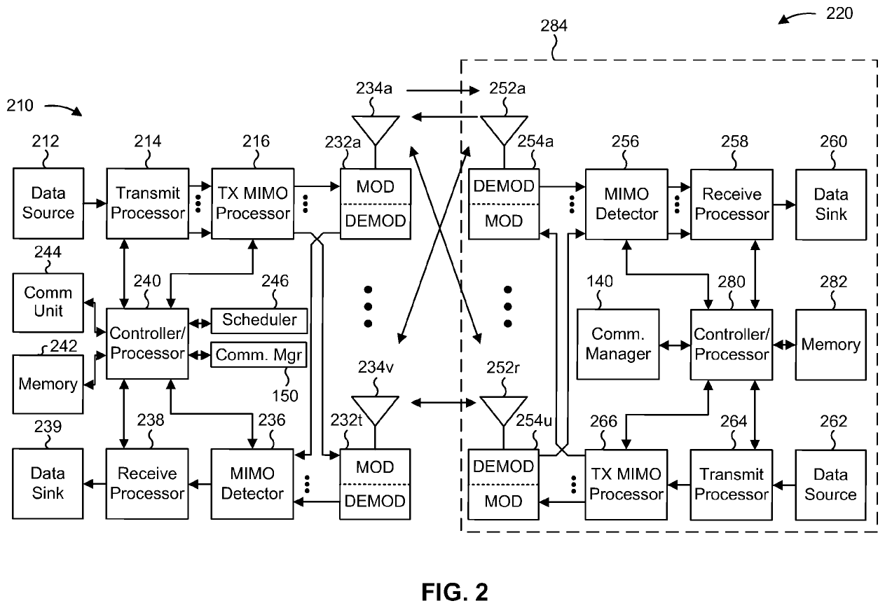

FIG. 2 is a diagram illustrating an example network node 210 in communication with an example UE 220 in a wireless network in accordance with the present disclosure. The network node 210 of FIG. 2 may be an example of the network node 110 described with reference to FIG. 1. Similarly, the UE 220 may be an example of the UE 120 described with reference to FIG. 1.

As shown in FIG. 2, the network node 210 may include a data source 212, a transmit processor 214, a transmit (TX) multiple-input multiple-output (MIMO) processor 216, a set of modems 232 (shown as 232a through 232t, where t≥1), a set of antennas 234 (shown as 234a through 234v, where v ≥1), a MIMO detector 236, a receive processor 238, a data sink 239, a controller/processor 240, a memory 242, a communication unit 244, a scheduler 246, and/or a communication manager 150 among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 210. The transceiver may be under control of and used by a processor, such as the controller/processor 240, and in some aspects in conjunction with processor-readable code stored in the memory 242, to perform aspects of the methods, processes, and/or operations described herein. In some aspects, the network node 210 may include one or more interfaces, communication components, and/or other components that facilitate communication with the UE 220 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 210 may include transmit processor 214, TX MIMO processor 216, MIMO detector 236, receive processor 238, and/or controller/processor 240. Similarly, one or more processors of the UE 220 may include MIMO detector 256, receive processor 258, transmit processor 264, TX MIMO processor 266, and/or controller/processor 280. As used herein, “processor,” “controller,” or “controller/processor” can refer to a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof. A general purpose processor may be a microprocessor or any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

In some aspects, an individual processor may perform all of the operations described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

For downlink communication from the network node 210 to the UE 220, the transmit processor 214 may receive data (“downlink data”) intended for the UE 220 (or a set of UEs that includes the UE 220) from the data source 212 (such as a data pipeline or a data queue). In some examples, the transmit processor 214 may select one or more MCSs for the UE 220 in accordance with one or more channel quality indicators (CQIs) received from the UE 220. The network node 210 may process the data (for example, including encoding the data) for transmission to the UE 220 on a downlink in accordance with the MCS(s) selected for the UE 220 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC-CE communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 220 to the network node 210, uplink signals from the UE 220 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 210 may use the scheduler 246 to schedule one or more UEs 220 for downlink or uplink communications. In some aspects, the scheduler 246 may use DCI to dynamically schedule DL transmissions to the UE 220 and/or UL transmissions from the UE 220. In some examples, the scheduler 246 may allocate recurring time domain resources and/or frequency domain resources that the UE 220 may use to transmit and/or receive communications using an RRC configuration (for example, a semi-static configuration), for example, to perform semi-persistent scheduling (SPS) or to configure a configured grant (CG) for the UE 220.

One or more of the transmit processor 214, the TX MIMO processor 216, the modem 232, the antenna 234, the MIMO detector 236, the receive processor 238, and/or the controller/processor 240 may be included in an RF chain of the network node 210. An RF chain may include filters, mixers, oscillators, amplifiers, analog-to-digital converters (ADCs), and/or other devices that convert between an analog signal (such as for transmission or reception via an air interface) and a digital signal (such as for processing by one or more processors of the network node 210). In some aspects, the RF chain may be or may be included in a transceiver of the network node 210.

In some examples, the network node 210 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 210 may use the communication unit 244 to transmit and/or receive data associated with the UE 220 or to perform network control signaling, among other examples. The communication unit 244 may include a transceiver and/or an interface, such as a network interface.

The UE 220 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 220 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 220. The transceiver may be under control of and used by a processor, such as the controller/processor 280, and in some aspects in conjunction with processor-readable code stored in the memory 282, to perform aspects of the methods, processes, or operations described herein. In some aspects, the UE 220 may include another interface, another communication component, and/or another component that facilitates communication with the network node 210 and/or another UE 220.

For downlink communication from the network node 210 to the UE 220, the set of antennas 252 may receive the downlink communications or signals from the network node 210 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 220 to the data sink 260 (such as a data pipeline, a data queue, and/or an application executed on the UE 220), and may provide decoded control information and system information to the controller/processor 280.

For uplink communication from the UE 220 to the network node 210, the transmit processor 264 may receive and process data (“uplink data”) from a data source 262 (such as a data pipeline, a data queue, and/or an application executed on the UE 220) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 210 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 220 by the network node 210.

The transmit processor 264 may generate reference symbols for one or more reference signals, such as an uplink DMRS, an uplink SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, R output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254r may transmit a set of uplink signals (for example, R uplink signals) via the corresponding set of antennas 252. An uplink signal may include an uplink control information (UCI) communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 220) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 220 or network nodes 110 may include different numbers of antenna elements. For example, a UE 220 may include a single antenna element, two antenna elements, four antenna elements, eight antenna elements, or a different number of antenna elements. As another example, a network node 210 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

The network node 210 may provide the UE 220 with a configuration of TCI states that indicate or correspond to beams that may be used by the UE 220, such as for receiving one or more communications via a physical channel. For example, the network node 210 may indicate (for example, using DCI) an activated TCI state to the UE 220, which the UE 220 may use to generate a beam for receiving one or more communications via the physical channel. A beam indication may be, or may include, a TCI state information element, a beam identifier (ID), spatial relation information, a TCI state ID, a closed loop index, a panel ID, a TRP ID, and/or an SRS set ID, among other examples. A TCI state information element (sometimes referred to as a TCI state herein) may indicate particular information associated with a beam. For example, the TCI state information element may indicate a TCI state identification (for example, a tci-StateID), a quasi-co-location (QCL) type (for example, a qcl-Type1, qcl-Type2, qcl-TypeA, qcl-TypeB, qcl-TypeC, or a qcl-TypeD, among other examples), a cell identification (for example, a ServCellIndex), a bandwidth part identification (bwp-Id), or a reference signal identification, such as a CSI-RS identification (for example, an NZP-CSI-RS-Resourceld or an SSB-Index, among other examples). Spatial relation information may similarly indicate information associated with an uplink beam. The beam indication may be a joint or separate DL/UL beam indication in a unified TCI framework. In a unified TCI framework, the network may support common TCI state ID update and activation, which may provide common QCL and/or common UL transmission spatial filters across a set of configured component carriers. This type of beam indication may apply to intra-band carrier aggregation, as well as to joint DL/UL and separate DL/UL beam indications. The common TCI state ID may imply that one reference signal determined according to the TCI state(s) indicated by a common TCI state ID is used to provide QCL Type-D indication and to determine UL transmission spatial filters across the set of configured CCs.

In some examples, the network may support a layer 1 (L1)-based beam indication using at least UE-specific (unicast) DCI to indicate joint or separate DL/UL beam indications that may be selected from active TCI states. In some examples, DCI formats 1_1 and/or 1_2 may be used for beam indication. The network node 210 may include a support mechanism for the UE 220 to acknowledge successful decoding of a beam indication. For example, the acknowledgment/negative acknowledgment of the PDSCH scheduled by the DCI carrying the beam indication may also be used as an acknowledgement for the DCI.

Further efficiencies in throughput, signal strength, and/or other signal properties may be achieved through beam refinement. For example, the network node 210 may be capable of communicating with the UE 220 using beams of various beam widths. For example, the network node 210 may be configured to utilize a wider beam to communicate with the UE 220 when the UE 220 is in motion because wider coverage may increase the likelihood that the UE 220 remains in coverage of the network node 210 while moving. Conversely, the network node 210 may use a narrower beam to communicate with the UE 220 when the UE 220 is stationary because the network node 210 can reliably focus coverage on the UE 220 with low or minimal likelihood of the UE 220 moving out of the coverage area of the network node 210. In some examples, to select a particular beam for communication with a UE 220, the network node 210 may transmit a reference signal, such as a synchronization signal block (SSB) or a CSI-RS, on each of a plurality of beams in a beam-sweeping manner. In some examples, SSBs may be transmitted on wider beams, whereas CSI-RSs may be transmitted on narrower beams. The UE 220 may measure the RSRP or the signal-to-interference-plus-noise ratio (SINR) on each of the beams and transmit a beam measurement report (for example, an L1 measurement report) to the network node 210 indicating the RSRP or SINR associated with each of one or more of the measured beams. The network node 210 may then select the particular beam for communication with the UE 220 based on the L1 measurement report. In some other examples, when there is channel reciprocity between the uplink and the downlink, the network node 210 may derive the particular beam to communicate with the UE 220 (for example, on both the uplink and downlink) based on uplink measurements of one or more uplink reference signals, such as an SRS, transmitted by the UE 220.

One enhancement for multi-beam operation at higher carrier frequencies is facilitation of efficient (for example, low latency and low overhead) downlink and/or uplink beam management operations to support higher Layer 1 and/or Layer 2 (L1/L2)-centric inter-cell mobility. L1 and/or L2 signaling may be referred to as “lower layer” signaling and may be used to activate and/or deactivate candidate cells in a set of cells configured for L1/L2 mobility and/or to provide reference signals for measurement by the UE 220, by which the UE 220 may select a candidate beam as a target beam for a lower layer handover operation. Accordingly, one goal for L1/L2-centric inter-cell mobility is to enable a UE to perform a cell switch via dynamic control signaling at lower layers (for example, DCI for L1 signaling or a MAC-CE for L2 signaling), rather than semi-static Layer 3 (L3) RRC signaling, in order to reduce latency, reduce overhead, and/or otherwise increase efficiency of the cell switch.

In some examples, for a UE 220, UL transmission may be performed using one antenna panel, and DL reception may be performed using another antenna panel. In some examples, full-duplex communication may be conditional on a beam separation of the UL beam and DL beam at respective antenna panels. Utilizing full-duplex communication may provide a reduction in latency, such that it may be possible to receive a DL signal in UL-only slots, which may enable latency savings. In addition, full-duplex communication may enhance spectrum efficiency per cell or per UE 220, and may enable more efficient utilization of resources. Beam separation of the UL and DL beams assists in limiting or reducing self-interference that may occur during full duplex communication. UL and DL beams that are separated on their respective antenna panels may provide reliable full duplex communication by minimizing or reducing self-interference.

A full-duplex UE 220 may perform a self-interference measurement (SIM) procedure to identify self-interference from transmissions of the full-duplex UE 220. A full-duplex network node 210 also may perform a SIM procedure to identify self-interference from transmissions of the full-duplex network node 210. The UE 220 may provide a measurement report to the network node 210 to indicate results of the UE SIM. The network node 210 may select pairs of beams (referred to herein as “beam pairs”) for the UE 220 (“UE beam pairs”) and the network node 210 (“network node beam pairs”) to use during full-duplex communications. A beam pair generally includes a receive (Rx) beam and a transmit (Tx) beam, such as a DL beam and an UL beam, respectively, for the UE 220, and similarly, an UL beam and a DL beam, respectively, for the network node 210.

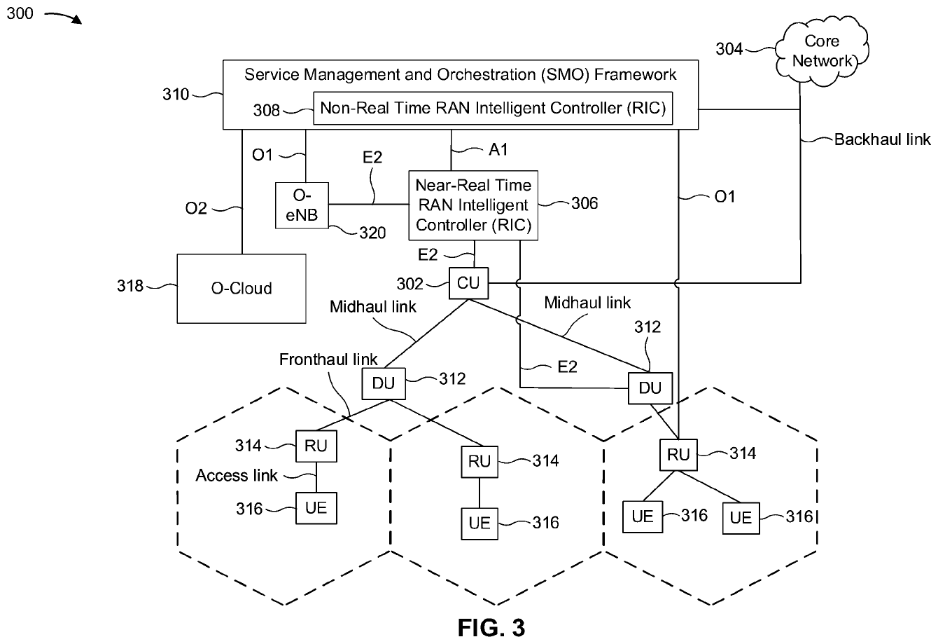

FIG. 3 is a diagram illustrating an example disaggregated base station architecture 300 in accordance with the present disclosure. One or more components of the example disaggregated base station architecture 300 may be, include, or be included in, one or more network nodes (such one or more network nodes 110 or one or more network nodes 210). The disaggregated base station architecture 300 may include a CU 302 that can communicate directly with a core network 304 via a backhaul link, or indirectly with the core network 304 through one or more disaggregated control units (such as a Near-RT RIC 306 via an E2 link, or a Non-RT RIC 308 associated with a Service Management and Orchestration (SMO) Framework 310, or both). The CU 302 may communicate with one or more DUs 312 via respective midhaul links, such as through F1 interfaces. Each of the DUs 312 may communicate with one or more RUs 314 via respective fronthaul links. Each of the RUs 314 may communicate with one or more UEs 316 via respective RF access links. In some deployments, a UE 316 may be simultaneously served by multiple RUs 314.

Each of the components of the disaggregated base station architecture 300, including the CUS 302, the DUs 312, the RUs 314, as well as the Near-RT RICs 306, the Non-RT RICs 308, and the SMO Framework 310, may include one or more interfaces or be coupled with one or more interfaces for receiving or transmitting signals, data, or information (collectively, signals) via a wired or wireless transmission medium.

In some aspects, the CU 302 may host one or more higher layer control functions. Such control functions can include RRC functions, PDCP functions, or SDAP functions, among other examples. Each control function can be implemented with an interface for communicating signals with other control functions hosted by the CU 302. The CU 302 may handle user plane functionality (for example, Central Unit-User Plane (CU-UP) functionality), and/or control plane functionality (for example, Central Unit Control Plane (CU-CP) functionality). In some implementations, the CU 302 can be logically split into one or more CU-UP units and one or more CU-CP units. A CU-UP unit can communicate bidirectionally with a CU-CP unit via an interface, such as the El interface when implemented in an O-RAN configuration. The CU 302 can be deployed to communicate with one or more DUs 312, as necessary, for network control and signaling.

Each DU 312 may correspond to a logical unit that includes one or more base station functions to control the operation of one or more RUs 314. In some aspects, the DU 312 may host one or more of an RLC layer, a MAC layer, and one or more high PHY layers depending, at least in part, on a functional split, such as a functional split defined by the 3GPP. In some implementations, the one or more high PHY layers may be implemented by one or more modules for forward error correction (FEC) encoding and decoding, scrambling, and modulation and demodulation, among other examples. In some implementations, the DU 312 may further host one or more low PHY layers, such as implemented by one or more modules for an FFT, an iFFT, digital beamforming, or PRACH extraction and filtering, among other examples. Each layer (which also may be referred to as a module) can be implemented with an interface for communicating signals with other layers (and modules) hosted by the DU 312, or with the control functions hosted by the CU 302.

Each RU 314 may implement lower-layer functionality. In some deployments, an RU 314, controlled by a DU 312, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 314 can be operated to handle OTA communication with one or more UEs 316. In some implementations, real-time and non-real-time aspects of control and user plane communication with the RU(s) 314 can be controlled by the corresponding DU 312. In some deployments, this configuration can enable each DU 312 and the CU 302 to be implemented in a cloud-based RAN architecture, such as a vRAN architecture.

The SMO Framework 310 may support RAN deployment and provisioning of non-virtualized and virtualized network elements. For non-virtualized network elements, the SMO Framework 310 may support the deployment of dedicated physical resources for RAN coverage requirements, which may be managed via an operations and maintenance interface (such as an O1 interface). For virtualized network elements, the SMO Framework 310 may interact with a cloud computing platform (such as an open cloud (O-Cloud) platform 318) to perform network element life cycle management (such as to instantiate virtualized network elements) via a cloud computing platform interface (such as an O2 interface). Such virtualized network elements can include, but are not limited to, CUs 302, DUs 312, RUs 314, non-RT RICs 308, and Near-RT RICs 306. In some implementations, the SMO Framework 310 can communicate with a hardware aspect of a 4G RAN, a 5G NR RAN, and/or a 6G RAN, such as an open eNB (O-eNB) 320, via an O1 interface. Additionally, in some implementations, the SMO Framework 310 can communicate directly with each of one or more RUs 314 via a respective O1 interface. The SMO Framework 310 also may include a Non-RT RIC 308 that supports functionality of the SMO Framework 310.

The Non-RT RIC 308 may include or implement a logical function that enables non-real-time control and optimization of RAN elements and resources, Artificial Intelligence/Machine Learning (AI/ML) workflows including model training and updates, or policy-based guidance of applications/features in the Near-RT RIC 306. The Non-RT RIC 308 may be coupled to or communicate with (such as via an Al interface) the Near-RT RIC 306. The Near-RT RIC 306 may include or implement a logical function that enables near-real-time control and optimization of RAN elements and resources via data collection and actions over an interface (such as via an E2 interface) connecting one or more CUs 302, one or more DUs 312, or both, as well as an O-eNB 320, with the Near-RT RIC 306.

In some implementations, to generate AI/ML models to be deployed in the Near-RT RIC 306, the Non-RT RIC 308 may receive parameters or external enrichment information from external servers. Such information may be utilized by the Near-RT RIC 306 and may be received at the SMO Framework 310 or the Non-RT RIC 308 from non-network data sources or from network functions. In some examples, the Non-RT RIC 308 or the Near-RT RIC 306 may tune RAN behavior or performance. For example, the Non-RT RIC 308 may monitor long-term trends and patterns for performance and employ AI/ML models to perform corrective actions through the SMO Framework 310 (such as reconfiguration via an O1 interface) or via creation of RAN management policies (such as Al interface policies).

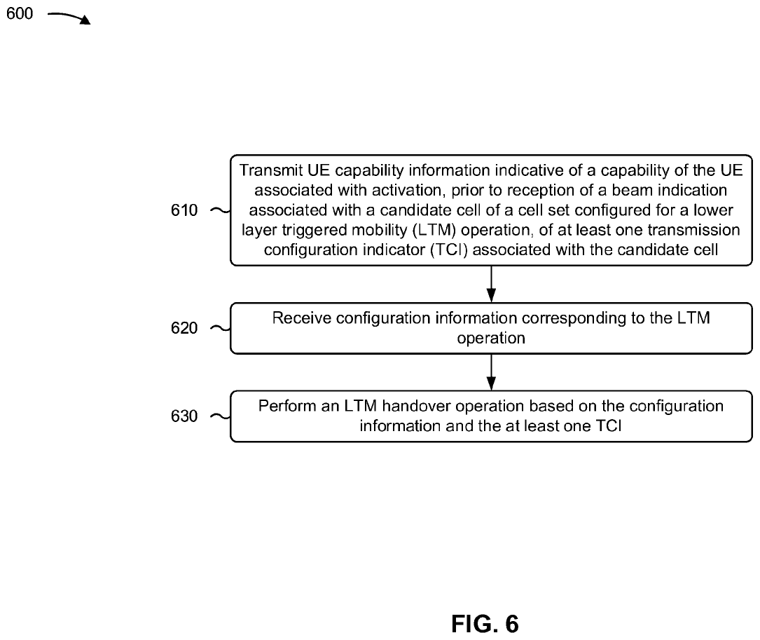

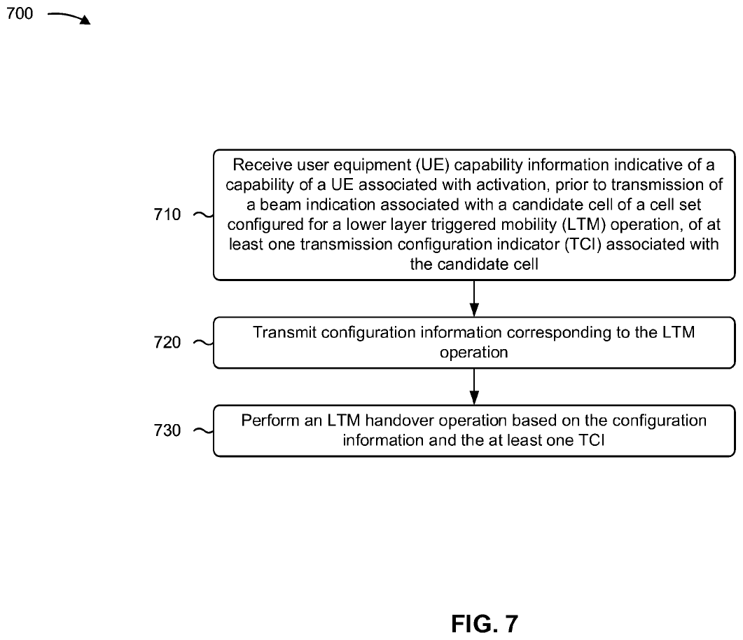

The network node 110, the controller/processor 240 of the network node 210, the UE 120, the controller/processor 280 of the UE 220, the CU 302 of FIG. 3, the DU 312 of FIG. 3, the RU 340 of FIG. 3, or any other component(s) of FIGS. 1, 2, or 3 may implement one or more techniques or perform one or more operations associated with beam indications for a candidate cell group in an LTM operation, as described in more detail elsewhere herein. For example, the controller/processor 240 of the network node 210, the controller/processor 280 of the UE 220, or any other component(s) of FIG. 2 may be operable to perform or direct operations of, for example, process 600 of FIG. 6, process 700 of FIG. 7, or other processes as described herein. The memory 242 and the memory 282 may store data and program codes for the network node 110/210 and the UE 120/220, respectively. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 210, the UE 220, the CU 302 of FIG. 3, the DU 312 of FIG. 3, or the RU 340 of FIG. 3, may cause the one or more processors to perform process 600 of FIG. 6, process 700 of FIG. 7, or other processes as described herein, or other processes as described herein. In some examples, executing instructions may include running the instructions, converting the instructions, compiling the instructions, or interpreting the instructions, among other examples. As used herein, “processor,” “controller,” or “controller/processor” can refer to a general purpose processor, a DSP, an application-ASIC, an FPGA or other PLD, discrete gate or transistor logic, discrete hardware components, or any combination thereof. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

In some aspects, a UE (e.g., the UE 220) includes means for transmitting UE capability information indicative of a capability of the UE associated with activation, prior to reception of a beam indication associated with a candidate cell of a cell set configured for an LTM operation, of at least one TCI associated with the candidate cell; means for receiving configuration information corresponding to the LTM operation; and/or means for performing an LTM handover operation based on the configuration information and the at least one TCI. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 210) includes means for receiving UE capability information indicative of a capability of a UE associated with activation, prior to transmission of a beam indication associated with a candidate cell of a cell set configured for an LTM operation, of at least one TCI associated with the candidate cell; means for transmitting configuration information corresponding to the LTM operation; and/or means for performing an LTM handover operation based on the configuration information and the at least one TCI. The means for the network node to perform operations described herein may include, for example, one or more of communication manager 150, transmit processor 214, TX MIMO processor 230, modem 232, antenna 234, MIMO detector 236, receive processor 238, controller/processor 240, memory 242, or scheduler 246.

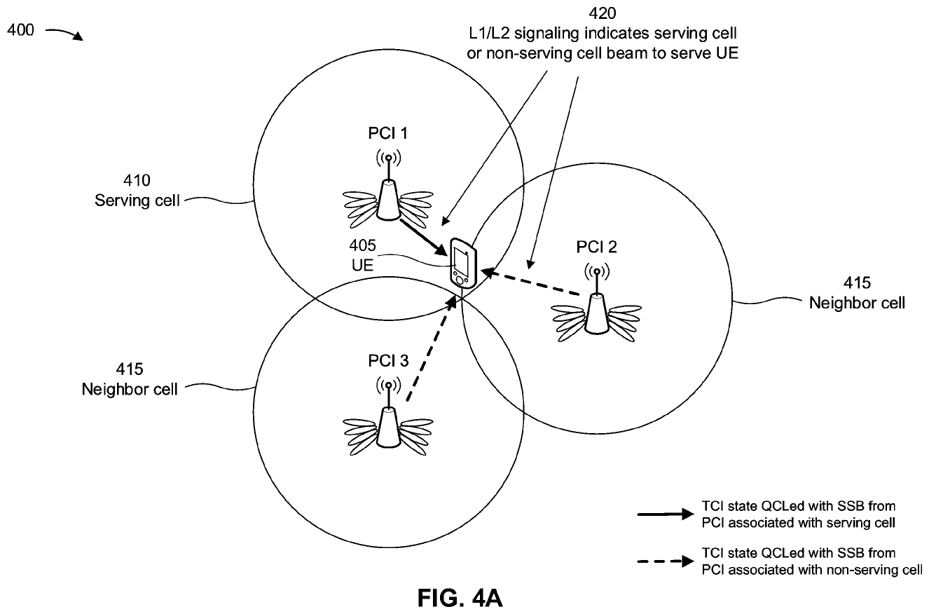

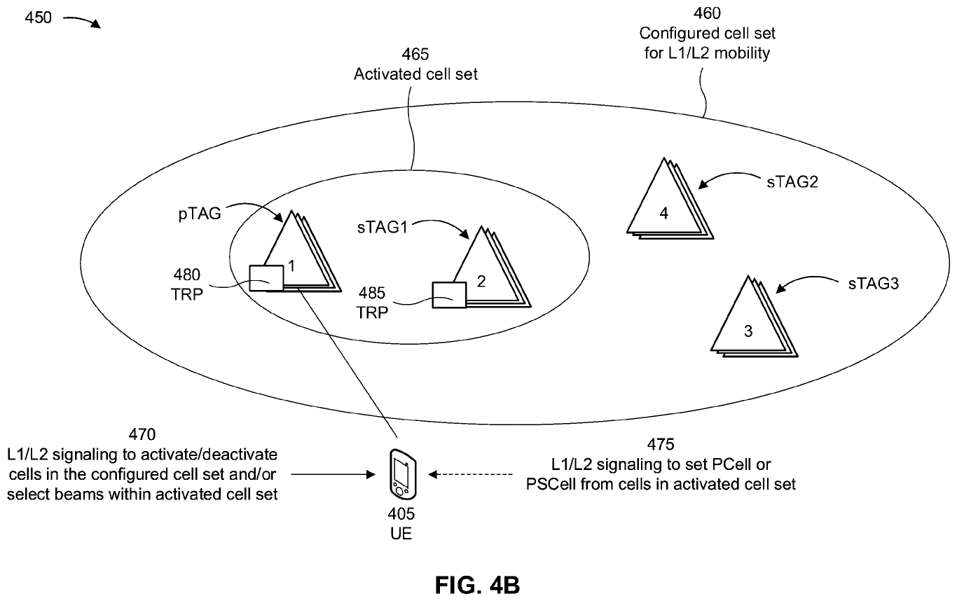

FIG. 4A illustrates an example 400 of a first LTM technique, in accordance with the present disclosure. The first LTM technique may be referred to as inter-cell mobility scheme 1, beam-based inter-cell mobility, dynamic point selection based inter-cell mobility, and/or non-serving cell-based inter-cell mobility, among other examples. As described in further detail herein, the first LTM technique may enable a network node to use L1 signaling (e.g., DCI) or L2 signaling (e.g., a MAC CE) to indicate that a UE 405 is to communicate on an access link using a beam from a serving cell or a non-serving cell. For example, in a wireless network where LTM is not supported (e.g., cell switches are triggered only by an L3 handover), beam selection for control information and for data is typically limited to beams within a physical cell identifier (PCI) associated with a serving cell. In contrast, in a wireless network that supports the first LTM technique (e.g., as shown in FIG. 4A), beam selection for control and data may be expanded to include any beams within a serving cell 410 or one or more non-serving neighbor cells 415 configured for LTM.

For example, in the first LTM technique shown in FIG. 4A, a UE 405 may be configured with a single serving cell 410, and the UE 405 may be further configured with a neighbor cell set that includes one or more non-serving neighbor cells 415 configured for LTM. In general, the serving cell 410 and the non-serving neighbor cells 415 that are configured for LTM may be associated with a common CU and a common DU, or the serving cell 410 and the non-serving neighbor cells 415 configured for LTM may be associated with a common CU and different DUs. In some aspects, as shown by reference number 420, a base station may trigger LTM for a UE using L1/L2 signaling (e.g., DCI or a MAC-CE) that indicates a selected TCI state QCLed with a reference signal (e.g., an SSB) associated with a PCI. For example, in FIG. 4A, the UE may be communicating with the serving cell 410 using a TCI state that is QCLed with an SSB from a PCI associated with the serving cell 410 (e.g., shown as PCI 1 in FIG. 4A), and lower layer (e.g., L1/L2) signaling may trigger inter-cell mobility by indicating that the UE 405 is to switch to communicating using a TCI state that is QCLed with an SSB from a PCI associated with a non-serving neighbor cell 415 (e.g., shown as PCI 2 in FIG. 4A). Accordingly, in the first LTM technique, the network node (e.g., the common CU controlling the serving cell 410 and the non-serving neighbor cells 415) may use L1/L2 signaling to select a beam from either the serving cell 410 or a non-serving neighbor cell 415 to serve the UE 405.

In this way, relative to restricting L1/L2 beam selection to beams within the serving cell 410, the first LTM technique may be more robust against blocking and may provide more opportunities for higher rank spatial division multiplexing across different cells. However, the first LTM technique does not enable support for changing a primary cell (PCell) or a primary secondary cell (PSCell) for a UE 405. Rather, in the first LTM technique, triggering a PCell or PSCell change is performed via a legacy L3 handover using RRC signaling. In this respect, the first LTM technique is associated with a limitation that L1/L2 signaling can only be used to indicate a beam from the serving cell 410 or a configured neighbor cell 415 while the UE 405 is in the coverage area of the serving cell 410 because L1/L2 signaling cannot be used to change the PCell or PSCell.

Accordingly, FIG. 4B illustrates an example 450 of a second LTM technique, in accordance with the present disclosure. The second LTM technique may be referred to as inter-cell mobility scheme 2 and/or serving-cell-based inter-cell mobility, among other examples. As described in further detail herein, the second LTM technique may enable a network node to use L1/L2 signaling (e.g., DCI or a MAC-CE) to indicate control information associated with an activated cell set and/or a deactivated cell set, and/or to indicate a change to a PCell or a PSCell within the activated cell set.

For example, as shown in FIG. 4B, the second LTM technique may use mechanisms that are generally similar to carrier aggregation to enable LTM, except that different cells configured for LTM may be on the same carrier frequency. As shown in FIG. 4B, a network node may configure a cell set 460 for LTM (e.g., using RRC signaling) that includes at least a cell 1 (“1”), a cell 2 (“2”), a cell 3 (“3”), and a cell 4 (“4”). As further shown, an activated cell set 465 may include one or more cells in the configured cell set 460 that are activated and ready to use for data and/or control transfer. The activated cell set 465 may include cell 1 and cell 2, for example. Cell 1 may be a PCell, and cell 2 may be a PSCell. Accordingly, in the second LTM technique, a deactivated cell set may include one or more cells (cell 3 and cell 4) that are included in the cell set 460 configured for LTM but are not included in the activated cell set 465. However, the cells that are included in the deactivated cell set can be readily activated, and thereby added to the activated cell set 465, using L1/L2 signaling. Accordingly, as shown by reference number 470, L1/L2 signaling can be used for mobility management of the activated cell set 465. For example, in some aspects, L1/L2 signaling can be used to activate cells within the configured cell set 460 (e.g., to add cells to the activated cell set 465), to deactivate cells in the activated cell set 465, and/or to select beams within the cells included in the activated cell set 465. In this way, the second LTM technique may enable seamless mobility among the cells included in the activated cell set 465 using L1/L2 signaling (e.g., using beam management techniques).

Furthermore, as shown by reference number 475, the second LTM technique enables using L1/L2 signaling to set or change a PCell or PSCell from the cells that are included in the activated cell set 465. Additionally, or alternatively, when the cell that is to become the new PCell or PSCell is in the deactivated cell set (e.g., is included in the cell set 460 configured for LTM but not the activated cell set 465), L1/L2 signaling can be used to move the cell from the deactivated cell set to the activated cell set 465 before further L1/L2 signaling is used to set the cell as the new PCell or PSCell. However, in the second LTM technique, an L3 handover (using RRC signaling) is used to change the PCell or PSCell when the new PCell or PSCell is not included in the cell set 460 configured for LTM. In such cases, RRC signaling associated with the L3 handover may be used to update the cells included in the cell set 460 that is configured for LTM.

In some aspects, multiple TRPs 480 and 485 may transmit communications (for example, the same communication or different communications) in the same transmission time interval (TTI) (for example, a slot, a mini-slot, a subframe, or a symbol) or different TTIs using different QCL relationships (for example, different spatial parameters, different TCI states, different precoding parameters, or different beamforming parameters). In some aspects, a TCI state may be used to indicate one or more QCL relationships. A TRP 480 may be configured to individually (for example, using dynamic selection) or jointly (for example, using joint transmission with one or more other TRPs 485) serve traffic to a UE 405. In some aspects, the TRP 480 and/or the TRP 485 may be, include, or be included in, one or more network nodes 110 described above in connection with FIGS. 1 and 2. In some examples, different TRPs 480 and 485 may be included in different base stations and/or other network nodes. In some cases, multiple TRPs 480 and 485 may be included in a single base station and/or other network node. In some cases, a TRP 480 and/or a TRP 485 may be referred to as a network node, a cell, a panel, an antenna array, and/or an array.

The cells in the LTM configured cell set 460 can belong to timing advance groups (TAGs), which may include a primary TAG (pTAG) and/or a secondary TAG (sTAG). “TAG” may refer to a group of cells that have the same (or similar within a threshold value) uplink TA values. For example, a first uplink carrier and a second uplink carrier may have different propagation delays between the UE 405 and the TRP 480 associated with cell 1 and between the UE 405 and the TRP 485. For example, the TRP 480 and the TRP 485 may not be co-located with one another, resulting in different propagation delays for uplink transmissions to reach a respective TRP on the different uplink carriers. As a result, the first uplink carrier and the second uplink carrier may have different timing advance values for uplink transmissions and may belong to different TAGs.

The UE 405 may use a timing advance value for an uplink carrier to transmit an uplink communication on the uplink carrier with a timing that results in synchronization of TTIs with a TRP 480 or 485, to reduce inter-TTI interference.

In some cases, TCI state activation (sometimes referred to as “TCI activation”) of a candidate cell can be received before the reception of a beam indication of the candidate cell. In some other cases, TCI state activation of a candidate cell can be received together with the reception of the beam indication of the candidate cell. However, some wireless communication standards may not provide signalling for the TCI state activation and the beam indication.

Various aspects relate generally to LTM operations. Some aspects more specifically relate to beam indications for a candidate cell group in an LTM operation. In some examples, a UE may transmit UE capability information to a network node that indicates a capability of the UE associated with activation of a TCI state prior to reception of a beam indication. For example, in some aspects, the UE capability information may indicate that the UE supports TCI activation prior to beam indication. In some other aspects, the UE capability information may indicate that the UE supports TCI activation with beam indication. In some aspects, the UE may be provided with a TCI activation communication (e.g., a MAC CE) prior to receiving a beam indication. In some other aspects, the UE may be provided with a TCI activation (e.g., in a cell switching command) along with a beam indication associated with a beam of a candidate cell. The UE may activate the TCI, activate the beam, and perform an LTM handover in association with the activated TCI and beam.

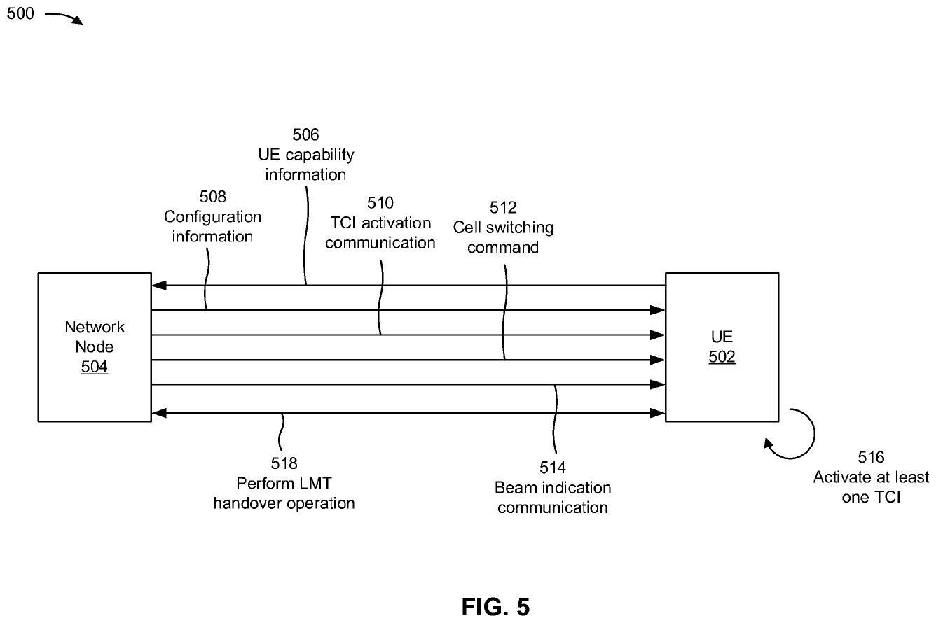

FIG. 5 is a diagram illustrating an example 500 associated with layer-3-based layer 1 measurement operations for LTM, in accordance with the present disclosure. As shown in FIG. 5, a UE 502 and a network node 504 may communicate with one another. In some aspects, the UE 502 may be, be similar to, include, or be included in, the UE 405 depicted in FIGS. 4A and 4B and/or the UE 120 depicted in FIGS. 1-3. In some aspects, the network node 504 may be, be similar to, include, or be included in, the TRP 480 and/or the TRP 485 depicted in FIG. 4B, the network node 110 depicted in FIGS. 1 and 2, and/or one or more components of the disaggregated base station architecture 300 depicted in FIG. 3. In some aspects, the network node 504 may include one or more TRPs and may provide a number of cells. The network node 504 may be associated with a source cell (e.g., a currently active cell with which the UE 502 is in a connected state). The source cell also may be a PCell and/or a special cell (SpCell)). The network node 504 may be associated with an SCell.

As shown by reference number 506, the UE 502 may transmit, and the network node 504 may receive, UE capability information. In some aspects, the UE capability information may be indicative of a capability of the UE 502 associated with activation, prior to reception of a beam indication associated with a candidate cell of a cell set configured for an LTM operation, of at least one TCI associated with the candidate cell. In some aspects, the capability of the UE 502 may be associated with at least one of a component carrier (CC), a band, or a band combination.

As shown by reference number 508, the network node 504 may transmit, and the UE 502 may receive, configuration information. In some aspects, the configuration information may be transmitted using an RRC communication. The configuration information may correspond to an LTM operation associated with a cell set configured for the LTM operation. In some aspects, the configuration information may include additional configuration information that includes an mTRP configuration. In some aspects, the mTRP configuration may include a single-DCI based mTRP configuration or a multiple-DCI based mTRP configuration.

As shown by reference number 510, the network node 504 may transmit, and the UE 502 may receive, a TCI activation communication. The TCI activation communication may indicate activation of at least one TCI. In some aspects, the TCI activation communication may include a MAC CE. In some aspects, the TCI activation communication may include DCI (e.g., TCI activation DCI). The TCI activation communication may include a cell ID associated with a candidate cell. In some aspects, the TCI activation communication may include at least one of a downlink BWP ID or an uplink BWP ID associated with the candidate cell. The TCI activation communication may indicate the at least one TCI to be activated.

In some aspects, for example, a TCI activation MAC CE may include a cell ID, and a downlink and/or uplink BWP ID for a corresponding candidate cell. For a candidate cell configured with mTRP, the UE 502 may be activated with at least a TCI codepoint with up to two joint TCIs, or up to two downlink (DL) TCIs and two uplink (UL) TCIs for a single-DCI (sDCI) based mTRP. A mapping order between TCIs and TRPs may be implicitly determined based on a rule such as, for example, based on a TCI ID order and/or a TRP ID order. For example, the UE 502 may be activated with at least two TCI codepoints with each mapped with a joint TCI, or a pair of DL and UL TCIs for multiple-DCI (mDCI) based mTRP. In some aspects, a mapping order between TCI codepoints and TRP IDs and/or control resource set (CORESET) pool indexes may be indicated by a TCI codepoint. In some aspects, the mapping order may be implicitly determined based on a rule.

For example, in some aspects, the UE 502 may receive additional configuration information including an mTRP configuration and, based on the mTRP configuration, the TCI activation communication may activate a TCI codepoint with the at least one TCI, the at least one TCI including at least one joint TCI. The at least one joint TCI may include one joint TCI or two joint TCIs. In some aspects, the UE 502 may receive additional configuration information including a single-DCI mTRP configuration and, based on the single-DCI mTRP configuration, the TCI activation communication may activate at least one of a downlink TCI or an uplink TCI. The at least one of the downlink TCI or the uplink TCI may include less than or equal to two downlink TCIs and less than or equal to two uplink TCIs. In some aspects, a mapping between the at least one TCI and at least one TRP associated with the single-DCI mTRP configuration may be based on a mapping rule.

In some aspects, the UE 502 may receive additional configuration information including an mTRP configuration and, based on the mTRP configuration, the TCI activation communication may activate a first TCI codepoint and a second TCI codepoint. The first TCI codepoint may be mapped with a first joint TCI of the at least one TCI, and the second TCI codepoint may be mapped with a second joint TCI of the at least one TCI. In some aspects, the first TCI codepoint may be mapped with a first uplink TCI of the at least one TCI and a first downlink TCI of the at least one TCI, and the second TCI codepoint may be mapped with a second uplink TCI of the at least one TCI and a second downlink TCI of the at least one TCI. In some aspects, a mapping order associated with a set of mappings associated with the first TCI codepoint and the second TCI codepoint may be indicated by at least one of the first TCI codepoint, a second TCI codepoint, or a third TCI codepoint. The set of mappings may include at least one of a mapping between the first TCI codepoint and at least one of a first TRP ID or a first CORESET ID, or the mapping between the second TCI codepoint and at least one of a second TRP ID or a second CORESET ID. In some aspects, a mapping order associated with a set of mappings associated with the first TCI codepoint and the second TCI codepoint may be based on a mapping rule.

In some aspects, a TCI activation DCI may include a cell ID and a DL and/or UL BWP ID for a corresponding candidate cell. For example, the UE 502 may receive a TCI ID in the DCI (e.g., indicated using reserved bits). In some aspects, the UE 502 may receive an SSB indication in the DCI, and the UE 502 may apply the first TCI ID with the indicated SSB as a root QCL source. In some aspects, TCIs to be activated may be only for a candidate cell that is a future target cell. For example, a future target cell may be a candidate cell indicated in the next cell switching command or in next cell switching commands in a following time window. The UE 502 may expect to receive a cell switching command within a time for a candidate cell after the TCI is activated or after the TCI activation command for the candidate cell. A starting time of the time window may be associated with at least one of an activation time associated with the at least one TCI or a time associated with reception of the TCI activation communication.

In some aspects, to activate TCIs for a candidate cell with the beam indication of the candidate cell, the UE 502 may receive a cell switching command with one joint TCI or one pair of DL and/or UL TCIs, and the UE 502 may activate the indicated TCI(s) after the beam indication and then apply the indication beam. For a candidate cell configured with mTRP, the UE 502 may be activated with a TCI codepoint with up to two joint TCIs, or up to two DL TCIs and two UL TCIs for single DCI based mTRP. The mapping order between TCIs and TRPs may be implicitly determined based on a rule. In some aspects, the UE 502 may be activated with two TCI codepoints, each mapped with a joint TCI, or a pair of DL and UL TCIs for mDCI based mTRP. In some aspects, the mapping order between TCI codepoints and TRP IDs and/or CORESET pool indexes may be indicated by a TCI codepoint. In some aspects, the mapping order may be implicitly determined based on a rule.

As shown by reference number 512, for example, the network node 504 may transmit, and the UE 502 may receive, a cell switching command. The cell switching command may activate the at least one TCI. For example, the cell switching command may indicate the at least one TCI. In some aspects, the at least one TCI includes one joint TCI. In some other aspects, the at least one TCI may include a downlink TCI and an uplink TCI. In some aspects, the UE 502 may receive additional configuration information including an mTRP configuration and, based on the mTRP configuration, the cell switching command may indicate an activation of a TCI codepoint with the at least one TCI, the at least one TCI including at least one joint TCI. For example, the at least one joint TCI may include one joint TCI or two joint TCIs. In some aspects, the UE 502 may receive additional configuration information including a single-DCI mTRP configuration and, based on the single-DCI mTRP configuration, the cell switching command may indicate at least one of a downlink TCI or an uplink TCI. The at least one of the downlink TCI or the uplink TCI may include less than or equal to two downlink TCIs and less than or equal to two uplink TCIs.

In some aspects, the UE 502 may receive additional configuration information including an mTRP configuration and, based on the mTRP configuration, the cell switching command may indicate a first TCI codepoint and a second TCI codepoint. In some aspects, the first TCI codepoint may be mapped with a first join TCI of the at least one TCI, and the second TCI codepoint may be mapped with a second joint TCI of the at least one TCI. In some aspects, the first TCI codepoint may be mapped with a first uplink TCI of the at least one TCI and a first downlink TCI of the at least one TCI, and the second TCI codepoint may be mapped with a second uplink TCI of the at least one TCI and a second downlink TCI of the at least one TCI. In some aspects, a mapping order associated with a set of mappings associated with the first TCI codepoint and the second TCI codepoint may be indicated by at least one of the first TCI codepoint, a second TCI codepoint, or a third TCI codepoint. The set of mappings may include at least one of a mapping between the first TCI codepoint and at least one of a first TRP ID or a first CORESET ID, or a mapping between the second TCI codepoint and at least one of a second TRP ID or a second CORESET ID. In some aspects, a mapping order associated with a set of mappings associated with the first TCI codepoint and the second TCI codepoint may be based on a mapping rule.

As shown by reference number 514, the network node 504 may transmit, and the UE 502 may receive, a beam indication communication. The beam indication communication may indicate the beam of the candidate cell to be used for the LTM handover operation. As shown by reference number 516, the UE 502 may activate the at least one TCI and, as shown by reference number 518, the UE 502 and the network node 504 may perform an LTM handover operation. In some aspects, for example, the network node 504 refers to more than one network nodes. For example, in some aspects, the network node 504 may include a first TRP associated with a serving cell and a second TRP associated with a candidate cell (e.g., a cell to which the UE 502 hands over). In some aspects, the UE 502 may perform the LTM handover operation with an additional network node (not shown).

In LTM operations, for TCI activation before or together with the cell switching command for one or more target CCs, if the target CCs belong to multiple CC lists where all CCs in one list are configured to share a common beam indication, each CC list may have a TCI activation to at least one CC in the list. For example, based on a target CC belonging to a plurality of CC lists and a common beam indication applying to at least one CC list of the plurality of CC lists, the at least one TCI may include a plurality of TCIs corresponding to the plurality of CC lists, each of the plurality of TCIs corresponding to at least one CC in a respective CC list of the plurality of CC lists. If a target CC is not in any CC list, the CC may be provided with an individual TCI activation. For example, in some aspects, based on a target CC being omitted from a CC list, the TCI activation communication may indicate an activation of a TCI associated with the target CC, or the cell switching command may indicate a beam associated with the target CC.

FIG. 6 is a diagram illustrating an example process 600 performed, for example, by a UE, in accordance with the present disclosure. Example process 600 is an example where the UE (e.g., UE 502) performs operations associated with beam indications for a candidate cell group in an LTM operation.

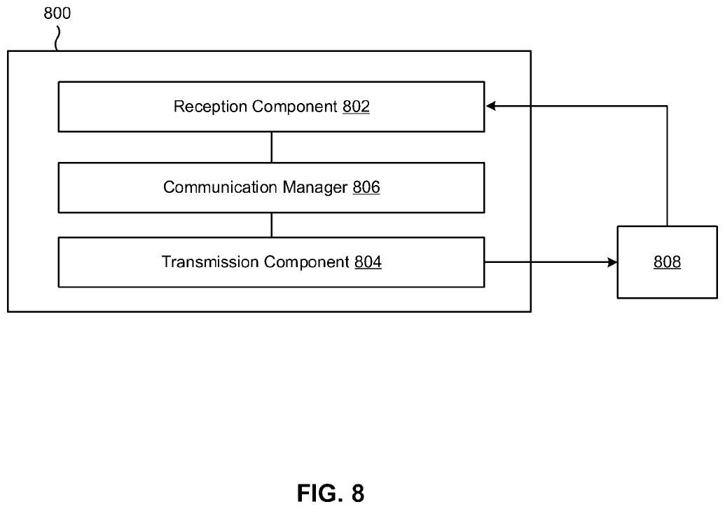

As shown in FIG. 6, in some aspects, process 600 may include transmitting UE capability information indicative of a capability of the UE associated with activation, prior to reception of a beam indication associated with a candidate cell of a cell set configured for an LTM operation, of at least one TCI associated with the candidate cell (block 610). For example, the UE (e.g., using transmission component 804 and/or communication manager 806, depicted in FIG. 8) may transmit UE capability information indicative of a capability of the UE associated with activation, prior to reception of a beam indication associated with a candidate cell of a cell set configured for an LTM operation, of at least one TCI associated with the candidate cell, as described above.

As further shown in FIG. 6, in some aspects, process 600 may include receiving configuration information corresponding to the LTM operation (block 620). For example, the UE (e.g., using reception component 802 and/or communication manager 806, depicted in FIG. 8) may receive configuration information corresponding to the LTM operation, as described above.

As further shown in FIG. 6, in some aspects, process 600 may include performing an LTM handover operation based on the configuration information and the at least one TCI (block 630). For example, the UE (e.g., using communication manager 806, depicted in FIG. 8) may perform an LTM handover operation based on the configuration information and the at least one TCI, as described above.

Process 600 may include additional aspects, such as any single aspect or any combination of aspects described below and/or in connection with one or more other processes described elsewhere herein.

In a first aspect, the capability of the UE is associated with at least one of a component carrier, a band, or a band combination. In a second aspect, alone or in combination with the first aspect, process 600 includes receiving, prior to the reception of the beam indication, a TCI activation communication indicating an activation of the at least one TCI. In a third aspect, alone or in combination with the second aspect, the TCI activation communication comprises a TCI activation MAC CE. In a fourth aspect, alone or in combination with one or more of the second through third aspects, the TCI activation communication includes a cell ID associated with the candidate cell.

In a fifth aspect, alone or in combination with one or more of the second through fourth aspects, the TCI activation communication includes at least one of a downlink BWP ID or an uplink BWP ID associated with the candidate cell. In a sixth aspect, alone or in combination with one or more of the second through fifth aspects, process 600 includes receiving additional configuration information comprising a multiple transmission reception point (mTRP) configuration and, based on the mTRP configuration, the TCI activation communication activates a TCI codepoint with the at least one TCI, the at least one TCI comprising at least one joint TCI. In a seventh aspect, alone or in combination with the sixth aspect, the at least one joint TCI comprises one joint TCI or two joint TCIs.

In an eighth aspect, alone or in combination with one or more of the second through seventh aspects, process 600 includes receiving additional configuration information comprising a single-DCI multiple transmission reception point (mTRP) configuration and, based on the single-DCI mTRP configuration, the TCI activation communication activates at least one of a downlink TCI or an uplink TCI. In a ninth aspect, alone or in combination with the eighth aspect, the at least one of the downlink TCI or the uplink TCI comprises less than or equal to two downlink TCIs and less than or equal to two uplink TCIs. In a tenth aspect, alone or in combination with one or more of the eighth through ninth aspects, a mapping between the at least on TCI and at least one TRP associated with the single-DCI mTRP configuration is based on a mapping rule.

In an eleventh aspect, alone or in combination with one or more of the second through tenth aspects, process 600 includes receiving additional configuration information comprising a multiple transmission reception point (mTRP) configuration and, based on the mTRP configuration, the TCI activation communication activates a first TCI codepoint and a second TCI codepoint. In a twelfth aspect, alone or in combination with the eleventh aspect, the first TCI codepoint is mapped with a first join TCI of the at least one TCI and the second TCI codepoint is mapped with a second joint TCI of the at least one TCI. In a thirteenth aspect, alone or in combination with the eleventh aspect, the first TCI codepoint is mapped with a first uplink TCI of the at least one TCI and a first downlink TCI of the at least one TCI, and the second TCI codepoint is mapped with a second uplink TCI of the at least one TCI and a second downlink TCI of the at least one TCI. In a fourteenth aspect, alone or in combination with one or more of the eleventh through thirteenth aspects, a mapping order associated with a set of mappings associated with the first TCI codepoint and the second TCI codepoint is indicated by at least one of the first TCI codepoint, a second TCI codepoint, or a third TCI codepoint, the set of mappings comprising at least one of a mapping between the first TCI codepoint and at least one of a first TRP ID or a first CORESET ID, or a mapping between the second TCI codepoint and at least one of a second TRP ID or a second CORESET ID. In a fifteenth aspect, alone or in combination with one or more of the eleventh through thirteenth aspects, a mapping order associated with a set of mappings associated with the first TCI codepoint and the second TCI codepoint is based on a mapping rule, the set of mappings comprising at least one of a mapping between the first TCI codepoint and at least one of a first TRP ID or a first CORESET ID, or a mapping between the second TCI codepoint and at least one of a second TRP ID or a second CORESET ID.

In a sixteenth aspect, alone or in combination with the second aspect, the TCI activation communication comprises TCI activation DCI. In a seventeenth aspect, alone or in combination with the sixteenth aspect, the DCI indicates the at least one TCI. In an eighteenth aspect, alone or in combination with one or more of the sixteenth through seventeenth aspects, the DCI includes an SSB indication that indicates an SSB, the method further comprising applying a first TCI, of the at least one TCI, associated with the SSB as a root QCL source. In a nineteenth aspect, alone or in combination with one or more of the second through eighteenth aspects, the activation of the at least one TCI is based on the candidate cell comprising a future target cell. In a twentieth aspect, alone or in combination with the nineteenth aspect, the candidate cell comprises a future target cell based on the candidate cell being associated with at least one of a next cell switching command or a cell switching command to be received within a time window. In a twenty-first aspect, alone or in combination with the twentieth aspect, a starting time of the time window is associated with at least one of an activation time associated with the at least one TCI or a time associated with reception of the TCI activation communication.

In a twenty-second aspect, alone or in combination with the first aspect, process 600 includes receiving a cell switching command to activate the at least one TCI, the cell switching command indicating the at least one TCI, receiving a beam indication communication that indicates a beam associated with the candidate cell, and activating the at least one TCI based on receiving the beam indication communication, wherein performing the LTM handover operation comprises applying the beam based on activating the at least one TCI. In a twenty-third aspect, alone or in combination with the twenty-second aspect, the at least one TCI comprises one joint TCI. In a twenty-fourth aspect, alone or in combination with the twenty-second aspect, the at least one TCI comprises a downlink TCI and an uplink TCI. In a twenty-fifth aspect, alone or in combination with the twenty-second aspect, process 600 includes receiving additional configuration information comprising a multiple transmission reception point (mTRP) configuration and, based on the mTRP configuration, the cell switching command indicates an activation of a TCI codepoint with the at least one TCI, the at least one TCI comprising at least one joint TCI. In a twenty-sixth aspect, alone or in combination with the twenty-fifth aspect, the at least one joint TCI comprises one joint TCI or two joint TCIs. In a twenty-seventh aspect, alone or in combination with the twenty-second aspect, process 600 includes receiving additional configuration information comprising a single-DCI multiple transmission reception point (mTRP) configuration and, based on the single-DCI mTRP configuration, the cell switching command indicates at least one of a downlink TCI or an uplink TCI. In a twenty-eighth aspect, alone or in combination with the twenty-seventh aspect, the at least one of the downlink TCI or the uplink TCI comprises less than or equal to two downlink TCIs and less than or equal to two uplink TCIs.

In a twenty-ninth aspect, alone or in combination with the twenty-second aspect, process 600 includes receiving additional configuration information comprising a multiple transmission reception point (mTRP) configuration and, based on the mTRP configuration, the cell switching command indicates a first TCI codepoint and a second TCI codepoint. In a thirtieth aspect, alone or in combination with the twenty-ninth aspect, the first TCI codepoint is mapped with a first join TCI of the at least one TCI and the second TCI codepoint is mapped with a second joint TCI of the at least one TCI. In a thirty-first aspect, alone or in combination with the twenty-ninth aspect, the first TCI codepoint is mapped with a first uplink TCI of the at least one TCI and a first downlink TCI of the at least one TCI, and the second TCI codepoint is mapped with a second uplink TCI of the at least one TCI and a second downlink TCI of the at least one TCI.

In a thirty-second aspect, alone or in combination with one or more of the twenty-ninth through thirty-first aspects, a mapping order associated with a set of mappings associated with the first TCI codepoint and the second TCI codepoint may be indicated by at least one of the first TCI codepoint, a second TCI codepoint, or a third TCI codepoint, the set of mappings comprising at least one of a mapping between the first TCI codepoint and at least one of a first TRP ID or a first CORESET ID, or a mapping between the second TCI codepoint and at least one of a second TRP ID or a second CORESET ID. In a thirty-third aspect, alone or in combination with one or more of the twenty-ninth through thirty-first aspects, a mapping order associated with a set of mappings associated with the first TCI codepoint and the second TCI codepoint may be based on a mapping rule, the set of mappings comprising at least one of a mapping between the first TCI codepoint and at least one of a first TRP ID or a first CORESET ID, or a mapping between the second TCI codepoint and at least one of a second TRP ID or a second CORESET ID.

In a thirty-fourth aspect, alone or in combination with one or more of the first through thirty-third aspects, based on a target CC belonging to a plurality of CC lists and a common beam indication applying to at least one CC list of the plurality of CC lists, the at least one TCI comprises a plurality of TCIs corresponding to the plurality of CC lists, each of the plurality of TCIs corresponding to at least one CC in a respective CC list of the plurality of CC lists. In a thirty-fifth aspect, alone or in combination with one or more of the first through thirty-fourth aspects, based on a target CC being omitted from a CC list, the activation communication further indicates an activation of a TCI associated with the target CC, or the cell switching command further indicates a beam associated with the target CC.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 504) performs operations associated with beam indications for a candidate cell group in an LTM operation.

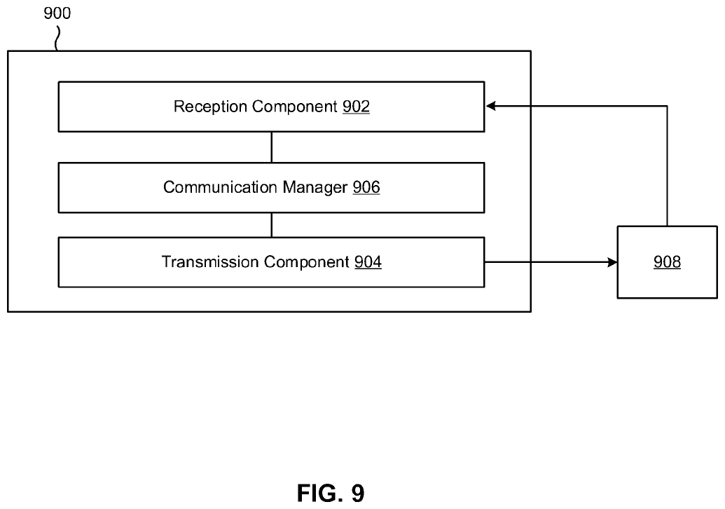

As shown in FIG. 7, in some aspects, process 700 may include receiving UE capability information indicative of a capability of a UE associated with activation, prior to transmission of a beam indication associated with a candidate cell of a cell set configured for an LTM operation, of at least one TCI associated with the candidate cell (block 710). For example, the network node (e.g., using reception component 902 and/or communication manager 906, depicted in FIG. 9) may receive UE capability information indicative of a capability of a UE associated with activation, prior to transmission of a beam indication associated with a candidate cell of a cell set configured for an LTM operation, of at least one TCI associated with the candidate cell, as described above.

As further shown in FIG. 7, in some aspects, process 700 may include transmitting configuration information corresponding to the LTM operation (block 720). For example, the network node (e.g., using transmission component 904 and/or communication manager 906, depicted in FIG. 9) may transmit configuration information corresponding to the LTM operation, as described above.

As further shown in FIG. 7, in some aspects, process 700 may include performing an LTM handover operation based on the configuration information and the at least one TCI (block 730). For example, the network node (e.g., using communication manager 906, depicted in FIG. 9) may perform an LTM handover operation based on the configuration information and the at least one TCI, as described above.

Process 700 may include additional aspects, such as any single aspect or any combination of aspects described below and/or in connection with one or more other processes described elsewhere herein.

In a first aspect, the capability of the UE is associated with at least one of a component carrier, a band, or a band combination. In a second aspect, alone or in combination with the first aspect, process 700 includes transmitting, prior to the transmission of the beam indication, a TCI activation communication indicating an activation of the at least one TCI. In a third aspect, alone or in combination with the second aspect, the TCI activation communication comprises a TCI activation MAC CE. In a fourth aspect, alone or in combination with one or more of the second through third aspects, the TCI activation communication includes a cell ID associated with the candidate cell.

In a fifth aspect, alone or in combination with one or more of the second through fourth aspects, the TCI activation communication includes at least one of a downlink BWP ID or an uplink BWP ID associated with the candidate cell. In a sixth aspect, alone or in combination with one or more of the second through fifth aspects, process 700 includes transmitting additional configuration information comprising a multiple transmission reception point (mTRP) configuration and, based on the mTRP configuration, the TCI activation communication activates a TCI codepoint with the at least one TCI, the at least one TCI comprising at least one joint TCI. In a seventh aspect, alone or in combination with the sixth aspect, the at least one joint TCI comprises one joint TCI or two joint TCIs.

In an eighth aspect, alone or in combination with one or more of the second through seventh aspects, process 700 includes transmitting additional configuration information comprising a single-DCI multiple transmission reception point (mTRP) configuration and, based on the single-DCI mTRP configuration, the TCI activation communication activates at least one of a downlink TCI or an uplink TCI. In a ninth aspect, alone or in combination with the eighth aspect, the at least one of the downlink TCI or the uplink TCI comprises less than or equal to two downlink TCIs and less than or equal to two uplink TCIs. In a tenth aspect, alone or in combination with one or more of the eighth through ninth aspects, a mapping between the at least on TCI and at least one TRP associated with the single-DCI mTRP configuration is based on a mapping rule.

In an eleventh aspect, alone or in combination with one or more of the second through tenth aspects, process 700 includes transmitting additional configuration information comprising a multiple transmission reception point (mTRP) configuration and, based on the mTRP configuration, the TCI activation communication activates a first TCI codepoint and a second TCI codepoint. In a twelfth aspect, alone or in combination with the eleventh aspect, the first TCI codepoint is mapped with a first join TCI of the at least one TCI and the second TCI codepoint is mapped with a second joint TCI of the at least one TCI. In a thirteenth aspect, alone or in combination with the eleventh aspect, the first TCI codepoint is mapped with a first uplink TCI of the at least one TCI and a first downlink TCI of the at least one TCI, and the second TCI codepoint is mapped with a second uplink TCI of the at least one TCI and a second downlink TCI of the at least one TCI. In a fourteenth aspect, alone or in combination with one or more of the eleventh through thirteenth aspects, a mapping order associated with a set of mappings associated with the first TCI codepoint and the second TCI codepoint may be indicated by at least one of the first TCI codepoint, a second TCI codepoint, or a third TCI codepoint, the set of mappings comprising at least one of a mapping between the first TCI codepoint and at least one of a first TRP ID or a first CORESET ID, or a mapping between the second TCI codepoint and at least one of a second TRP ID or a second CORESET ID. In a fifteenth aspect, alone or in combination with one or more of the eleventh through fourteenth aspects, a mapping order associated with a set of mappings associated with the first TCI codepoint and the second TCI codepoint may be based on a mapping rule, the set of mappings comprising at least one of a mapping between the first TCI codepoint and at least one of a first TRP ID or a first CORESET ID, or a mapping between the second TCI codepoint and at least one of a second TRP ID or a second CORESET ID.

In a sixteenth aspect, alone or in combination with one or more of the second through fifteenth aspects, the TCI activation communication comprises TCI activation DCI. In a seventeenth aspect, alone or in combination with the sixteenth aspect, the DCI indicates the at least one TCI. In an eighteenth aspect, alone or in combination with one or more of the sixteenth through seventeenth aspects, the DCI includes an SSB indication that indicates an SSB, wherein a first TCI, of the at least one TCI, is associated with the SSB as a root QCL source.

In a nineteenth aspect, alone or in combination with one or more of the second through eighteenth aspects, the activation of the at least one TCI is based on the candidate cell comprising a future target cell. In a twentieth aspect, alone or in combination with the nineteenth aspect, the candidate cell comprises a future target cell based on the candidate cell being associated with at least one of a next cell switching command or a cell switching command to be received within a time window. In a twenty-first aspect, alone or in combination with the twentieth aspect, a starting time of the time window is associated with at least one of an activation time associated with the at least one TCI or a time associated with reception of the TCI activation communication.

In a twenty-second aspect, process 700 includes transmitting a cell switching command to activate the at least one TCI, the cell switching command indicating the at least one TCI, and transmitting a beam indication communication that indicates a beam associated with the candidate cell, wherein the at least one TCI is activated based on the beam indication communication, wherein performing the LTM handover operation comprises applying the beam based on activating the at least one TCI. In a twenty-third aspect, alone or in combination with the twenty-second aspect, the at least one TCI comprises one joint TCI. In a twenty-fourth aspect, alone or in combination with the twenty-second aspect, the at least one TCI comprises a downlink TCI and an uplink TCI.

In a twenty-fifth aspect, alone or in combination with one or more of the twenty-second through twenty-fourth aspects, process 700 includes transmitting additional configuration information comprising a multiple transmission reception point (mTRP) configuration and, based on the mTRP configuration, the cell switching command indicates an activation of a TCI codepoint with the at least one TCI, the at least one TCI comprising at least one joint TCI. In a twenty-sixth aspect, alone or in combination with the twenty-fifth aspect, the at least one joint TCI comprises one joint TCI or two joint TCIs. In a twenty-seventh aspect, alone or in combination with one or more of the twenty-second through twenty-sixth aspects, process 700 includes transmitting additional configuration information comprising a single-DCI multiple transmission reception point (mTRP) configuration and, based on the single-DCI mTRP configuration, the cell switching command indicates at least one of a downlink TCI or an uplink TCI. In a twenty-eighth aspect, alone or in combination with the twenty-seventh aspect, the at least one of the downlink TCI or the uplink TCI comprises less than or equal to two downlink TCIs and less than or equal to two uplink TCIs.

In a twenty-ninth aspect, alone or in combination with one or more of the twenty-second through twenty-eighth aspects, process 700 includes transmitting additional configuration information comprising a multiple transmission reception point (mTRP) configuration and, based on the mTRP configuration, the cell switching command indicates a first TCI codepoint and a second TCI codepoint. In a thirtieth aspect, alone or in combination with the twenty-ninth aspect, the first TCI codepoint is mapped with a first join TCI of the at least one TCI and the second TCI codepoint is mapped with a second joint TCI of the at least one TCI. In a thirty-first aspect, alone or in combination with the twenty-ninth aspect, the first TCI codepoint is mapped with a first uplink TCI of the at least one TCI and a first downlink TCI of the at least one TCI, and the second TCI codepoint is mapped with a second uplink TCI of the at least one TCI and a second downlink TCI of the at least one TCI.

In a thirty-second aspect, alone or in combination with one or more of the twenty-ninth through thirty-first aspects, a mapping order associated with a set of mappings associated with the first TCI codepoint and the second TCI codepoint is indicated by at least one of the first TCI codepoint, a second TCI codepoint, or a third TCI codepoint, the set of mappings comprising at least one of a mapping between the first TCI codepoint and at least one of a first TRP ID or a first CORESET ID, or a mapping between the second TCI codepoint and at least one of a second TRP ID or a second CORESET ID. In a thirty-third aspect, alone or in combination with one or more of the twenty-ninth through thirty-first aspects, a mapping order associated with a set of mappings associated with the first TCI codepoint and the second TCI codepoint may be based on a mapping rule, the set of mappings comprising at least one of a mapping between the first TCI codepoint and at least one of a first TRP ID or a first CORESET ID, or a mapping between the second TCI codepoint and at least one of a second TRP ID or a second CORESET ID.

In a thirty-fourth aspect, alone or in combination with one or more of the first through thirty-third aspects, based on a target CC belonging to a plurality of CC lists and a common beam indication applying to at least one CC list of the plurality of CC lists, the at least one TCI comprises a plurality of TCIs corresponding to the plurality of CC lists, each of the plurality of TCIs corresponding to at least one CC in a respective CC list of the plurality of CC lists. In a thirty-fifth aspect, alone or in combination with one or more of the first through thirty-fourth aspects, based on a target CC being omitted from a CC list, the activation communication further indicates an activation of a TCI associated with the target CC, or the cell switching command further indicates a beam associated with the target CC.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The transmission component 804 may transmit UE capability information indicative of a capability of the UE associated with activation, prior to reception of a beam indication associated with a candidate cell of a cell set configured for an LTM operation, of at least one TCI associated with the candidate cell. The reception component 802 may receive configuration information corresponding to the LTM operation. The communication manager 806 may perform an LTM handover operation based on the configuration information and the at least one TCI. The reception component 802 may receive, prior to the reception of the beam indication, a TCI activation communication indicating an activation of the at least one TCI.

The reception component 802 may receive additional configuration information comprising a multiple transmission reception point (mTRP) configuration and, based on the mTRP configuration, the TCI activation communication activates a TCI codepoint with the at least one TCI, the at least one TCI comprising at least one joint TCI. The reception component 802 may receive additional configuration information comprising a single-DCI multiple transmission reception point (mTRP) configuration and, based on the single-DCI mTRP configuration, the TCI activation communication activates at least one of a downlink TCI or an uplink TCI.

The reception component 802 may receive additional configuration information comprising a multiple transmission reception point (mTRP) configuration and, based on the mTRP configuration, the TCI activation communication activates a first TCI codepoint and a second TCI codepoint. The reception component 802 may receive a cell switching command to activate the at least one TCI, the cell switching command indicating the at least one TCI. The reception component 802 may receive a beam indication communication that indicates a beam associated with the candidate cell.

The communication manager 806 may activate the at least one TCI based on receiving the beam indication communication, wherein performing the LTM handover operation comprises applying the beam based on activating the at least one TCI. The reception component 802 may receive additional configuration information comprising a multiple transmission reception point (mTRP) configuration and, based on the mTRP configuration, the cell switching command indicates an activation of a TCI codepoint with the at least one TCI, the at least one TCI comprising at least one joint TCI.

The reception component 802 may receive additional configuration information comprising a single-DCI multiple transmission reception point (mTRP) configuration and, based on the single-DCI mTRP configuration, the cell switching command indicates at least one of a downlink TCI or an uplink TCI. The reception component 802 may receive additional configuration information comprising a multiple transmission reception point (mTRP) configuration and, based on the mTRP configuration, the cell switching command indicates a first TCI codepoint and a second TCI codepoint.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive UE capability information indicative of a capability of a UE associated with activation, prior to transmission of a beam indication associated with a candidate cell of a cell set configured for an LTM operation, of at least one TCI associated with the candidate cell. The transmission component 904 may transmit configuration information corresponding to the LTM operation. The communication manager 906 may perform an LTM handover operation based on the configuration information and the at least one TCI. The transmission component 904 may transmit, prior to the transmission of the beam indication, a TCI activation communication indicating an activation of the at least one TCI.

The transmission component 904 may transmit additional configuration information comprising a multiple transmission reception point (mTRP) configuration and, based on the mTRP configuration, the TCI activation communication activates a TCI codepoint with the at least one TCI, the at least one TCI comprising at least one joint TCI. The transmission component 904 may transmit additional configuration information comprising a single-DCI multiple transmission reception point (mTRP) configuration and, based on the single-DCI mTRP configuration, the TCI activation communication activates at least one of a downlink TCI or an uplink TCI.

The transmission component 904 may transmit additional configuration information comprising a multiple transmission reception point (mTRP) configuration and, based on the mTRP configuration, the TCI activation communication activates a first TCI codepoint and a second TCI codepoint. The transmission component 904 may transmit a cell switching command to activate the at least one TCI, the cell switching command indicating the at least one TCI. The transmission component 904 may transmit a beam indication communication that indicates a beam associated with the candidate cell, wherein the at least one TCI is activated based on the beam indication communication, wherein performing the LTM handover operation comprises applying the beam based on activating the at least one TCI.

The transmission component 904 may transmit additional configuration information comprising a multiple transmission reception point (mTRP) configuration and, based on the mTRP configuration, the cell switching command indicates an activation of a TCI codepoint with the at least one TCI, the at least one TCI comprising at least one joint TCI. The transmission component 904 may transmit additional configuration information comprising a single-DCI multiple transmission reception point (mTRP) configuration and, based on the single-DCI mTRP configuration, the cell switching command indicates at least one of a downlink TCI or an uplink TCI. The transmission component 904 may transmit additional configuration information comprising a multiple transmission reception point (mTRP) configuration and, based on the mTRP configuration, the cell switching command indicates a first TCI codepoint and a second TCI codepoint.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: transmitting UE capability information indicative of a capability of the UE associated with activation, prior to reception of a beam indication associated with a candidate cell of a cell set configured for a lower layer triggered mobility (LTM) operation, of at least one transmission configuration indicator (TCI) associated with the candidate cell; receiving configuration information corresponding to the LTM operation; and performing an LTM handover operation based on the configuration information and the at least one TCI.

Aspect 2: The method of Aspect 1, wherein the capability of the UE is associated with at least one of a component carrier, a band, or a band combination.

Aspect 3: The method of either of claims 1 or 2, further comprising receiving, prior to the reception of the beam indication, a TCI activation communication indicating an activation of the at least one TCI.

Aspect 4: The method of Aspect 3, wherein the TCI activation communication comprises a TCI activation medium access control (MAC) control element (MAC CE).

Aspect 5: The method of either of Aspects 3 or 4, wherein the TCI activation communication includes a cell identifier (ID) associated with the candidate cell.

Aspect 6: The method of any of Aspects 3-5, wherein the TCI activation communication includes at least one of a downlink bandwidth part (BWP) ID or an uplink BWP ID associated with the candidate cell.

Aspect 7: The method of any of Aspects 3-6, further comprising receiving additional configuration information comprising a multiple transmission reception point (mTRP) configuration and wherein, based on the mTRP configuration, the TCI activation communication activates a TCI codepoint with the at least one TCI, the at least one TCI comprising at least one joint TCI.

Aspect 8: The method of Aspect 7, wherein the at least one joint TCI comprises one joint TCI or two joint TCIs.

Aspect 9: The method of any of Aspects 3-6, further comprising receiving additional configuration information comprising a single-downlink control information (DCI) multiple transmission reception point (mTRP) configuration and wherein, based on the single-DCI mTRP configuration, the TCI activation communication activates at least one of a downlink TCI or an uplink TCI.

Aspect 10: The method of Aspect 9, wherein the at least one of the downlink TCI or the uplink TCI comprises less than or equal to two downlink TCIs and less than or equal to two uplink TCIs.

Aspect 11: The method of either of claims 9 or 10, wherein a mapping between the at least on TCI and at least one transmission reception point (TRP) associated with the single-DCI mTRP configuration is based on a mapping rule.

Aspect 12: The method of any of Aspects 3-6, further comprising receiving additional configuration information comprising a multiple transmission reception point (mTRP) configuration and wherein, based on the mTRP configuration, the TCI activation communication activates a first TCI codepoint and a second TCI codepoint.

Aspect 13: The method of Aspect 12, wherein the first TCI codepoint is mapped with a first join TCI of the at least one TCI and the second TCI codepoint is mapped with a second joint TCI of the at least one TCI.

Aspect 14: The method of any of Aspects 12-13, wherein the first TCI codepoint is mapped with a first uplink TCI of the at least one TCI and a first downlink TCI of the at least one TCI, and wherein the second TCI codepoint is mapped with a second uplink TCI of the at least one TCI and a second downlink TCI of the at least one TCI.

Aspect 15: The method of any of Aspects 12-14, wherein a mapping order associated with a set of mappings associated with the first TCI codepoint and the second TCI codepoint is indicated by at least one of the first TCI codepoint, a second TCI codepoint, or a third TCI codepoint, the set of mappings comprising at least one of: a mapping between the first TCI codepoint and at least one of a first TRP identifier (ID) or a first control resource set (CORESET) ID, or a mapping between the second TCI codepoint and at least one of a second TRP ID or a second CORESET ID.

Aspect 16: The method of any of Aspects 12-14, wherein a mapping order associated with a set of mappings associated with the first TCI codepoint and the second TCI codepoint is based on a mapping rule, the set of mappings comprising at least one of: a mapping between the first TCI codepoint and at least one of a first TRP identifier (ID) or a first control resource set (CORESET) ID, or a mapping between the second TCI codepoint and at least one of a second TRP ID or a second CORESET ID.

Aspect 17: The method of Aspect 3, wherein the TCI activation communication comprises TCI activation downlink control information (DCI).

Aspect 18: The method of Aspect 17, wherein the DCI indicates the at least one TCI.

Aspect 19: The method of either of Aspects 17 or 18, wherein the DCI includes a synchronization signal block (SSB) indication that indicates an SSB, the method further comprising applying a first TCI, of the at least one TCI, associated with the SSB as a root quasi co-location (QCL) source.

Aspect 20: The method of any of Aspects 3-19, wherein the activation of the at least one TCI is based on the candidate cell comprising a future target cell.

Aspect 21: The method of Aspect 20, wherein the candidate cell comprises a future target cell based on the candidate cell being associated with at least one of a next cell switching command or a cell switching command to be received within a time window.

Aspect 22: The method of Aspect 21, wherein a starting time of the time window is associated with at least one of an activation time associated with the at least one TCI or a time associated with reception of the TCI activation communication.

Aspect 23: The method of any of Aspects 3-22, wherein, based on a target component carrier (CC) belonging to a plurality of CC lists and a common beam indication applying to at least one CC list of the plurality of CC lists, the at least one TCI comprises a plurality of TCIs corresponding to the plurality of CC lists, each of the plurality of TCIs corresponding to at least one CC in a respective CC list of the plurality of CC lists.

Aspect 24: The method of any of Aspects 3-23, wherein, based on a target component carrier (CC) being omitted from a CC list, the activation communication further indicates an activation of a TCI associated with the target CC.

Aspect 25: The method of either of Aspects 1 or 2, further comprising: receiving a cell switching command to activate the at least one TCI, the cell switching command indicating the at least one TCI; receiving a beam indication communication that indicates a beam associated with the candidate cell; and activating the at least one TCI based on receiving the beam indication communication, wherein performing the LTM handover operation comprises applying the beam based on activating the at least one TCI.

Aspect 26: The method of Aspect 25, wherein the at least one TCI comprises one joint TCI.

Aspect 27: The method of Aspect 25, wherein the at least one TCI comprises a downlink TCI and an uplink TCI.

Aspect 28: The method of Aspect 25, further comprising receiving additional configuration information comprising a multiple transmission reception point (mTRP) configuration and wherein, based on the mTRP configuration, the cell switching command indicates an activation of a TCI codepoint with the at least one TCI, the at least one TCI comprising at least one joint TCI.

Aspect 29: The method of Aspect 28, wherein the at least one joint TCI comprises one joint TCI or two joint TCIs.

Aspect 30: The method of Aspect 25, further comprising receiving additional configuration information comprising a single-downlink control information (DCI) multiple transmission reception point (mTRP) configuration and wherein, based on the single-DCI mTRP configuration, the cell switching command indicates at least one of a downlink TCI or an uplink TCI.

Aspect 31: The method of Aspect 30, wherein the at least one of the downlink TCI or the uplink TCI comprises less than or equal to two downlink TCIs and less than or equal to two uplink TCIs.

Aspect 32: The method of Aspect 25, further comprising receiving additional configuration information comprising a multiple transmission reception point (mTRP) configuration and wherein, based on the mTRP configuration, the cell switching command indicates a first TCI codepoint and a second TCI codepoint.

Aspect 33: The method of Aspect 32, wherein the first TCI codepoint is mapped with a first join TCI of the at least one TCI and the second TCI codepoint is mapped with a second joint TCI of the at least one TCI.

Aspect 34: The method of Aspect 32, wherein the first TCI codepoint is mapped with a first uplink TCI of the at least one TCI and a first downlink TCI of the at least one TCI, and wherein the second TCI codepoint is mapped with a second uplink TCI of the at least one TCI and a second downlink TCI of the at least one TCI.

Aspect 35: The method of any of Aspects 32-34, wherein a mapping order associated with a set of mappings associated with the first TCI codepoint and the second TCI codepoint is indicated by at least one of the first TCI codepoint, a second TCI codepoint, or a third TCI codepoint, the set of mappings comprising at least one of: a mapping between the first TCI codepoint and at least one of a first TRP identifier (ID) or a first control resource set (CORESET) ID, or a mapping between the second TCI codepoint and at least one of a second TRP ID or a second CORESET ID.

Aspect 36: The method of any of Aspects 32-34, wherein a mapping order associated with a set of mappings associated with the first TCI codepoint and the second TCI codepoint is based on a mapping rule, the set of mappings comprising at least one of: a mapping between the first TCI codepoint and at least one of a first TRP identifier (ID) or a first control resource set (CORESET) ID, or a mapping between the second TCI codepoint and at least one of a second TRP ID or a second CORESET ID.

Aspect 37: The method of any of Aspects 25-36, wherein, based on a target component carrier (CC) belonging to a plurality of CC lists and a common beam indication applying to at least one CC list of the plurality of CC lists, the at least one TCI comprises a plurality of TCIs corresponding to the plurality of CC lists, each of the plurality of TCIs corresponding to at least one CC in a respective CC list of the plurality of CC lists.

Aspect 38: The method of any of Aspects 25-37, wherein, based on a target component carrier (CC) being omitted from a CC list, the cell switching command further indicates a beam associated with the target CC.

Aspect 39: A method of wireless communication performed by a network node, comprising: receiving user equipment (UE) capability information indicative of a capability of a UE associated with activation, prior to transmission of a beam indication associated with a candidate cell of a cell set configured for a lower layer triggered mobility (LTM) operation, of at least one transmission configuration indicator (TCI) associated with the candidate cell; transmitting configuration information corresponding to the LTM operation; and performing an LTM handover operation based on the configuration information and the at least one TCI.

Aspect 40: The method of Aspect 39, wherein the capability of the UE is associated with at least one of a component carrier, a band, or a band combination.

Aspect 41: The method of either of claims 39 or 40, further comprising transmitting, prior to the transmission of the beam indication, a TCI activation communication indicating an activation of the at least one TCI.

Aspect 42: The method of Aspect 41, wherein the TCI activation communication comprises a TCI activation medium access control (MAC) control element (MAC CE).

Aspect 43: The method of either of Aspects 41 or 42, wherein the TCI activation communication includes a cell identifier (ID) associated with the candidate cell.

Aspect 44: The method of any of Aspects 41-43, wherein the TCI activation communication includes at least one of a downlink bandwidth part (BWP) ID or an uplink BWP ID associated with the candidate cell.

Aspect 45: The method of any of Aspect 41-44, further comprising transmitting additional configuration information comprising a multiple transmission reception point (mTRP) configuration and wherein, based on the mTRP configuration, the TCI activation communication activates a TCI codepoint with the at least one TCI, the at least one TCI comprising at least one joint TCI.

Aspect 46: The method of Aspect 45, wherein the at least one joint TCI comprises one joint TCI or two joint TCIs.

Aspect 47: The method of any of Aspect 41-44, further comprising transmitting additional configuration information comprising a single-downlink control information (DCI) multiple transmission reception point (mTRP) configuration and wherein, based on the single-DCI mTRP configuration, the TCI activation communication activates at least one of a downlink TCI or an uplink TCI.

Aspect 48: The method of Aspect 47, wherein the at least one of the downlink TCI or the uplink TCI comprises less than or equal to two downlink TCIs and less than or equal to two uplink TCIs.

Aspect 49: The method of either of Aspects 47 or 48, wherein a mapping between the at least on TCI and at least one transmission reception point (TRP) associated with the single-DCI mTRP configuration is based on a mapping rule.

Aspect 50: The method of any of Aspect 41-44, further comprising transmitting additional configuration information comprising a multiple transmission reception point (mTRP) configuration and wherein, based on the mTRP configuration, the TCI activation communication activates a first TCI codepoint and a second TCI codepoint.

Aspect 51: The method of Aspect 50, wherein the first TCI codepoint is mapped with a first join TCI of the at least one TCI and the second TCI codepoint is mapped with a second joint TCI of the at least one TCI.

Aspect 52: The method of Aspect 50, wherein the first TCI codepoint is mapped with a first uplink TCI of the at least one TCI and a first downlink TCI of the at least one TCI, and wherein the second TCI codepoint is mapped with a second uplink TCI of the at least one TCI and a second downlink TCI of the at least one TCI.

Aspect 53: The method of any of Aspect 50-52, wherein a mapping order associated with a set of mappings associated with the first TCI codepoint and the second TCI codepoint is indicated by at least one of the first TCI codepoint, a second TCI codepoint, or a third TCI codepoint, the set of mappings comprising at least one of: a mapping between the first TCI codepoint and at least one of a first TRP identifier (ID) or a first control resource set (CORESET) ID, or a mapping between the second TCI codepoint and at least one of a second TRP ID or a second CORESET ID.

Aspect 54: The method of any of Aspect 50-52, wherein a mapping order associated with a set of mappings associated with the first TCI codepoint and the second TCI codepoint is based on a mapping rule, the set of mappings comprising at least one of: a mapping between the first TCI codepoint and at least one of a first TRP identifier (ID) or a first control resource set (CORESET) ID, or a mapping between the second TCI codepoint and at least one of a second TRP ID or a second CORESET ID.

Aspect 55: The method of any of Aspect 41-44, wherein the TCI activation communication comprises TCI activation downlink control information (DCI).

Aspect 56: The method of Aspect 55, wherein the DCI indicates the at least one TCI.

Aspect 57: The method of either of Aspects 55 or 56, wherein the DCI includes a synchronization signal block (SSB) indication that indicates an SSB, wherein a first TCI, of the at least one TCI, is associated with the SSB as a root quasi co-location (QCL) source.

Aspect 58: The method of any of Aspect 41-57, wherein the activation of the at least one TCI is based on the candidate cell comprising a future target cell.

Aspect 59: The method of Aspect 58, wherein the candidate cell comprises a future target cell based on the candidate cell being associated with at least one of a next cell switching command or a cell switching command to be received within a time window.

Aspect 60: The method of Aspect 59, wherein a starting time of the time window is associated with at least one of an activation time associated with the at least one TCI or a time associated with reception of the TCI activation communication.

Aspect 61: The method of any of Aspect 41-60, wherein, based on a target component carrier (CC) belonging to a plurality of CC lists and a common beam indication applying to at least one CC list of the plurality of CC lists, the at least one TCI comprises a plurality of TCIs corresponding to the plurality of CC lists, each of the plurality of TCIs corresponding to at least one CC in a respective CC list of the plurality of CC lists.

Aspect 62: The method of any of Aspect 41-61, wherein, based on a target component carrier (CC) being omitted from a CC list, the activation communication further indicates an activation of a TCI associated with the target CC.

Aspect 63: The method of Aspect 39, further comprising: transmitting a cell switching command to activate the at least one TCI, the cell switching command indicating the at least one TCI; and transmitting a beam indication communication that indicates a beam associated with the candidate cell, wherein the at least one TCI is activated based on the beam indication communication, wherein performing the LTM handover operation comprises applying the beam based on activating the at least one TCI.

Aspect 64: The method of Aspect 63, wherein the at least one TCI comprises one joint TCI.

Aspect 65: The method of Aspect 63, wherein the at least one TCI comprises a downlink TCI and an uplink TCI.

Aspect 66: The method of any of Aspects 63-65, further comprising transmitting additional configuration information comprising a multiple transmission reception point (mTRP) configuration and wherein, based on the mTRP configuration, the cell switching command indicates an activation of a TCI codepoint with the at least one TCI, the at least one TCI comprising at least one joint TCI.

Aspect 67: The method of Aspect 66, wherein the at least one joint TCI comprises one joint TCI or two joint TCIs.

Aspect 68: The method of any of Aspects 63-65, further comprising transmitting additional configuration information comprising a single-downlink control information (DCI) multiple transmission reception point (mTRP) configuration and wherein, based on the single-DCI mTRP configuration, the cell switching command indicates at least one of a downlink TCI or an uplink TCI.

Aspect 69: The method of Aspect 68, wherein the at least one of the downlink TCI or the uplink TCI comprises less than or equal to two downlink TCIs and less than or equal to two uplink TCIs.

Aspect 70: The method of any of Aspects 63-65, further comprising transmitting additional configuration information comprising a multiple transmission reception point (mTRP) configuration and wherein, based on the mTRP configuration, the cell switching command indicates a first TCI codepoint and a second TCI codepoint.

Aspect 71: The method of Aspect 70, wherein the first TCI codepoint is mapped with a first join TCI of the at least one TCI and the second TCI codepoint is mapped with a second joint TCI of the at least one TCI.

Aspect 72: The method of any of Aspects 70-71, wherein the first TCI codepoint is mapped with a first uplink TCI of the at least one TCI and a first downlink TCI of the at least one TCI, and wherein the second TCI codepoint is mapped with a second uplink TCI of the at least one TCI and a second downlink TCI of the at least one TCI.

Aspect 73: The method of any of Aspects 70-72, wherein a mapping order associated with a set of mappings associated with the first TCI codepoint and the second TCI codepoint is indicated by at least one of the first TCI codepoint, a second TCI codepoint, or a third TCI codepoint, the set of mappings comprising at least one of: a mapping between the first TCI codepoint and at least one of a first TRP identifier (ID) or a first control resource set (CORESET) ID, or a mapping between the second TCI codepoint and at least one of a second TRP ID or a second CORESET ID.

Aspect 74: The method of any of Aspects 70-72, wherein a mapping order associated with a set of mappings associated with the first TCI codepoint and the second TCI codepoint is based on a mapping rule, the set of mappings comprising at least one of: a mapping between the first TCI codepoint and at least one of a first TRP identifier (ID) or a first control resource set (CORESET) ID, or a mapping between the second TCI codepoint and at least one of a second TRP ID or a second CORESET ID.

Aspect 75: The method of any of Aspects 63-74, wherein, based on a target component carrier (CC) belonging to a plurality of CC lists and a common beam indication applying to at least one CC list of the plurality of CC lists, the at least one TCI comprises a plurality of TCIs corresponding to the plurality of CC lists, each of the plurality of TCIs corresponding to at least one CC in a respective CC list of the plurality of CC lists.

Aspect 76: The method of any of Aspects 63-75, wherein, based on a target component carrier (CC) being omitted from a CC list, the cell switching command further indicates a beam associated with the target CC.

Aspect 77: An apparatus for wireless communication at a device, comprising a processor; memory coupled with the processor; and instructions stored in the memory and executable by the processor to cause the apparatus to perform the method of one or more of Aspects 1-38.

Aspect 78: A device for wireless communication, comprising a memory and one or more processors coupled to the memory, the one or more processors configured to perform the method of one or more of Aspects 1-38.

Aspect 79: An apparatus for wireless communication, comprising at least one means for performing the method of one or more of Aspects 1-38.

Aspect 80: A non-transitory computer-readable medium storing code for wireless communication, the code comprising instructions executable by a processor to perform the method of one or more of Aspects 1-38.

Aspect 81: A non-transitory computer-readable medium storing a set of instructions for wireless communication, the set of instructions comprising one or more instructions that, when executed by one or more processors of a device, cause the device to perform the method of one or more of Aspects 1-38.

Aspect 82: An apparatus for wireless communication at a device, comprising a processor; memory coupled with the processor; and instructions stored in the memory and executable by the processor to cause the apparatus to perform the method of one or more of Aspects 39-76.

Aspect 83: A device for wireless communication, comprising a memory and one or more processors coupled to the memory, the one or more processors configured to perform the method of one or more of Aspects 39-76.

Aspect 84: An apparatus for wireless communication, comprising at least one means for performing the method of one or more of Aspects 39-76.

Aspect 85: A non-transitory computer-readable medium storing code for wireless communication, the code comprising instructions executable by a processor to perform the method of one or more of Aspects 39-76.

Aspect 86: A non-transitory computer-readable medium storing a set of instructions for wireless communication, the set of instructions comprising one or more instructions that, when executed by one or more processors of a device, cause the device to perform the method of one or more of Aspects 39-76.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of”′ a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, andc+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

1. A user equipment (UE) for wireless communication, comprising:
one or more memories; and
one or more processors, coupled to the one or more memories, configured to cause the UE to:
transmit UE capability information indicative of a capability of the UE associated with activation, prior to reception of a beam indication associated with a candidate cell of a cell set configured for a lower layer triggered mobility (LTM) operation, of at least one transmission configuration indicator (TCI) associated with the candidate cell;
receive configuration information corresponding to the LTM operation; and
perform an LTM handover operation based on the configuration information and the at least one TCI.

2. The UE of claim 1, wherein the capability of the UE is associated with at least one of a component carrier, a band, or a band combination.

3. The UE of claim 1, wherein the one or more processors are further configured to cause the UE to receive, prior to the reception of the beam indication, a TCI activation communication indicating an activation of the at least one TCI, wherein the TCI activation communication comprises a TCI activation medium access control (MAC) control element (MAC CE).

4. The UE of claim 3, wherein the TCI activation communication includes at least one of a cell identifier (ID) associated with the candidate cell, a downlink bandwidth part (BWP) ID or an uplink BWP ID associated with the candidate cell.

5. The UE of claim 3, wherein the one or more processors are further configured to cause the UE to receive additional configuration information comprising a multiple transmission reception point (mTRP) configuration and wherein, based on the mTRP configuration, the TCI activation communication activates a TCI codepoint with the at least one TCI, the at least one TCI comprising at least one joint TCI.

6. The UE of claim 3, wherein the one or more processors are further configured to cause the UE to receive additional configuration information comprising a single-downlink control information (DCI) multiple transmission reception point (mTRP) configuration and wherein, based on the single-DCI mTRP configuration, the TCI activation communication activates at least one of a downlink TCI or an uplink TCI.

7. The UE of claim 6, wherein a mapping between the at least on TCI and at least one transmission reception point (TRP) associated with the single-DCI mTRP configuration is based on a mapping rule.

8. The UE of claim 3, wherein the one or more processors are further configured to cause the UE to receive additional configuration information comprising a multiple transmission reception point (mTRP) configuration and wherein, based on the mTRP configuration, the TCI activation communication activates a first TCI codepoint and a second TCI codepoint.

9. The UE of claim 3, wherein the TCI activation communication comprises TCI activation downlink control information (DCI), and wherein the DCI indicates the at least one TCI.

10. (canceled)

11. The UE of claim 9, wherein the DCI includes a synchronization signal block (SSB) indication that indicates an SSB, and wherein the one or more processors are further configured to cause the UE to apply a first TCI, of the at least one TCI, associated with the SSB as a root quasi co-location (QCL) source.

12. (canceled)

13. The UE claim 3, wherein the activation of the at least one TCI is based on the candidate cell comprising a future target cell, and wherein the candidate cell comprises the future target cell based on the candidate cell being associated with at least one of a next cell switching command or a cell switching command to be received within a time window, wherein a starting time of the time window is associated with at least one of an activation time associated with the at least one TCI or a time associated with reception of the TCI activation communication.

14. The UE of claim 3, wherein, based on a target component carrier (CC) belonging to a plurality of CC lists and a common beam indication applying to at least one CC list of the plurality of CC lists, the at least one TCI comprises a plurality of TCIs corresponding to the plurality of CC lists, each of the plurality of TCIs corresponding to at least one CC in a respective CC list of the plurality of CC lists.

15. The UE of claim 3, wherein, based on a target component carrier (CC) being omitted from a CC list, the TCI activation communication further indicates an activation of a TCI associated with the target CC.

16. The UE of claim 1, wherein the one or more processors are further configured to cause the UE to:
receive a cell switching command to activate the at least one TCI, the cell switching command indicating the at least one TCI;
receive a beam indication communication that indicates a beam associated with the candidate cell; and
activate the at least one TCI based on receiving the beam indication communication, wherein performing the LTM handover operation comprises applying the beam based on activating the at least one TCI.

17. The UE of claim 16, wherein the one or more processors are further configured to cause the UE to receive additional configuration information comprising a multiple transmission reception point (mTRP) configuration and wherein, based on the mTRP configuration, the cell switching command indicates an activation of a TCI codepoint with the at least one TCI, the at least one TCI comprising at least one joint TCI.

18. The UE of claim 16, wherein the one or more processors are further configured to cause the UE to receive additional configuration information comprising a single-downlink control information (DCI) multiple transmission reception point (mTRP) configuration and wherein, based on the single-DCI mTRP configuration, the cell switching command indicates at least one of a downlink TCI or an uplink TCI.

19-23. (canceled)

24. A network node for wireless communication, comprising:
one or more memories; and
one or more processors, coupled to the one or more memories, configured to cause the network node to:
receive user equipment (UE) capability information indicative of a capability of a UE associated with activation, prior to transmission of a beam indication associated with a candidate cell of a cell set configured for a lower layer triggered mobility (LTM) operation, of at least one transmission configuration indicator (TCI) associated with the candidate cell;
transmit configuration information corresponding to the LTM operation; and
perform an LTM handover operation based on the configuration information and the at least one TCI.

25. The network node of claim 24, wherein the one or more processors are further configured to cause the network node to transmit, prior to the transmission of the beam indication, a TCI activation communication indicating an activation of the at least one TCI.

26. The network node of claim 24, wherein the one or more processors are further configured to cause the network node to:
transmit a cell switching command to activate the at least one TCI, the cell switching command indicating the at least one TCI; and
transmit a beam indication communication that indicates a beam associated with the candidate cell, wherein the at least one TCI is activated based on the beam indication communication, wherein performing the LTM handover operation comprises applying the beam based on activating the at least one TCI.

27. A method of wireless communication performed by a user equipment (UE), comprising:
transmitting UE capability information indicative of a capability of the UE associated with activation, prior to reception of a beam indication associated with a candidate cell of a cell set configured for a lower layer triggered mobility (LTM) operation, of at least one transmission configuration indicator (TCI) associated with the candidate cell;
receiving configuration information corresponding to the LTM operation; and
performing an LTM handover operation based on the configuration information and the at least one TCI.

28-30. (canceled)
